(19) United States
(12) Patent Application Publication
(10) Pub. No.: US 2004/0246294 A1
(43) Pub. Date: Dec. 9, 2004

(54) Method of cleaning print head

(76) Inventor: Toyohiko Mitsuzawa, Nagano-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 10/485,854

(22) PCT Filed: Apr. 21, 2003
(86) PCT No.: PCT/JP03/05087

(30) Foreign Application Priority Data
Apr. 22, 2002 (JP) 2002-119474

(51) Int. Cl. B41J 2/165

(52) U.S. Cl. 347/23

(57) ABSTRACT

A provides a technique for efficient nozzle testing and cleaning in a printing device equipped with a plurality of nozzle groups. Nozzle ejection testing is performed, and on the basis of ejection testing results, a nozzle group is selected as a target for cleaning, and cleaning is performed on the targeted nozzle group, whereby nozzle groups may be cleaned efficiently.

### TECHNICAL FIELD

This invention relates in general to a technique for printing images by means of ejecting ink from nozzles onto a print medium, and in particular to a technique for efficiently cleaning nozzles in a printing device equipped with a plurality of nozzle groups.

### BACKGROUND ART

Ink jet printers have come to enjoy widespread use as image output devices in recent years. An ink jet printer prints an image by ejecting ink onto a print medium while moving a print head having a plurality of nozzles. Printing devices compatible with relatively large paper sizes, such as A0 paper or roll paper, print images by means of a number of print heads.

In ink jet printers of this kind, ink misfire sometimes occurs due to nozzle clogging or variation in the amount of ink ejected from nozzles, resulting from an increase in ink viscosity, the presence of air bubbles, deposition of foreign matter, or the like. Printing devices compatible with relatively large paper sizes, such as A0 paper or roll paper, have several print heads, and thus employ a larger number of nozzles. Accordingly, there is a need to test and clean the nozzles in an efficient manner.

The present invention is directed to solving the aforementioned problem of the prior art, and has a first object to carry out efficiently testing of nozzles in a printing device equipped with a plurality of print heads. A second object is to carry out efficiently cleaning of nozzles.

### DISCLOSURE OF THE INVENTION

To solve the aforementioned problem at least in part, the printing device according to this invention provides a printing device that comprises a plurality of nozzle groups composed of nozzles supplied with ink from a common ink feed passage, and that prints images by ejecting ink from the nozzles onto a print medium, the device comprising a cleaning section for cleaning the nozzles of the nozzle groups; and a controller for executing a predetermined operation to test for ink misfire by the nozzles, and for controlling operation of the cleaning section; wherein the controller selects a target nozzle group targeted for cleaning based on the ejection test result.

The printing device according to this invention is able to perform selective cleaning of nozzle groups based on results of ink eject tests, whereby nozzle cleaning may be carried out efficiently.

In preferred practice, in the printing device herein, the controller determines a nozzle cleaning sequence with reference to at least one selected from ink refill schedule, ink tank replacement schedule, time elapsed since last printing operation, and ink type.

By so doing, cleaning can be carried out more appropriately, depending on environmental variables such as ink refill cycle, ink tank replacement cycle, time elapsed since last printing operation, and ink type.

In preferred practice, the printing device herein further comprises a testing unit having a light emitter for emitting light and a light receiver for receiving light; and able to perform ink ejection testing of nozzles; and the controller has a first ejection test mode wherein ink droplets are ejected from nozzles such that the paths of ink droplets from nozzles intersect the light, in order to detect misfire of the nozzles.

By so doing, a misfiring nozzle group can be detected readily.

In preferred practice, in the printing device herein, the controller comprises a test pattern printing section for printing a test pattern; and an input section permitting a user to input a misfiring nozzle designation; and having a second ejection test mode wherein ink misfire is detected in response to user input to the input section.

By so doing, detection of a misfiring nozzle can be carried out according to actual printed results.

In preferred practice, in the printing device herein, the cleaning section comprises a plurality of caps for hermetically covering at least one nozzle group; and a suctioning section for suctioning out gas present within the hermetic space between the caps and nozzle group; and the controller has a cleaning mode wherein a nozzle group is provided hermetic closure using at least the cap facing the nozzle group targeted for the cleaning.

By so doing, ink can be forcibly suctioned out from nozzles, so that cleaning of nozzles can be carried out more effectively.

In preferred practice, in the printing device herein, the caps are connected to the suctioning section by means of suctioning passages each having first opening/closing means; and the controller has a mode for performing a first type of suction cleaning wherein a target nozzle group is cleaned while closing the opening/closing means corresponding to caps other than the cap providing hermetic closure to the nozzle group targeted for the cleaning.

By so doing, precedence in cleaning may be given to a misfiring nozzle group, whereby the efficiency of cleaning may be increased.

In preferred practice, in the printing device herein, the caps are connected to the suctioning section by means of suctioning passages each having first opening/closing means; and the controller has a mode for performing a second type of suction cleaning wherein a target nozzle group targeted for the cleaning is cleaned by means of opening the first opening/closing means corresponding to the cap providing hermetic closure to the nozzle group after the opening/closing means has been closed for a first predetermined time interval, during operation of the suctioning section.

By so doing, the first opening/closing means can be opened in a state in which pressure in the suctioning passage is low. Thus, ink can be suctioned more forcefully from nozzles, so nozzles can be cleaned more effectively.

In preferred practice, in the printing device herein, the ink feed passages for the nozzle groups each have second opening/closing means; and the controller has a mode for performing a third type of suction cleaning wherein a target nozzle group targeted for the cleaning is cleaned by means of opening the second opening/closing means of the nozzle group after it has been closed for a second predetermined time interval, during operation of the suctioning section.

By so doing, the second opening/closing means can be opened in a state in which pressure is low in the hermetic space defined by the nozzle group and cap. Thus, ink can be suctioned more forcefully from nozzles, so nozzles can be cleaned more effectively.

In preferred practice in the printing device herein the suctioning section comprises suctioning means that enables the level of suction force to be modified; and the controller selects the suction force of the suctioning means depending on the type of cleaning.

By so doing, cleaning can be performed with a level of suction force appropriate to the type of cleaning.

In preferred practice, in the printing device herein, the suctioning section comprises a plurality of suctioning means having different levels of suction force; and the controller selects the suctioning means depending on the type of cleaning.

By so doing, cleaning can be performed with a level of suction force appropriate to the type of cleaning.

In preferred practice, in the printing device herein, the cleaning section comprises a plurality of wiper blades composed of resilient elements, for wiping the openings of the nozzles; and the controller has a cleaning mode wherein nozzle openings of a nozzle group are wiped using at least that the wiper blade which faces the nozzle group targeted for cleaning.

By so doing, nozzles can be cleaned forcefully using wiper blades composed of resilient elements such as rubber or sponge.

In preferred practice, in the printing device herein, a plurality of the wiper blades are disposed at the cap locations; and the cap and the wiper blade corresponding to a given nozzle group are replaceable as a single unit.

By so doing, in the event of a malfunction by the cap or wiper blade, the malfunctioning unit can be replaced individually, thereby facilitating maintenance.

In preferred practice, in the printing device herein, the controller is capable of offsetting the wiper blade from the nozzle group in the sub-scanning direction while positioning it away from the plane that includes the nozzle by means of moving at least either of the nozzle group and the wiper blade; and performs the wiping by means of a suitable combination of a first operation wherein the wiper blade is brought into proximity with the nozzle group while being kept offset therefrom, and a second operation wherein the wiper blade moves in the sub-scanning direction.

By so doing, a plurality of nozzles making up a nozzle group can be wiped, whereby the efficiency of wiping may be improved.

### OTHER ASPECTS OF THE INVENTION

The invention may additionally have other aspects, such as the following.

1. Printing device for performing printing on a print medium, the device comprising

a number N (where N is an integer equal to 2 or greater) of print heads each having a plurality of nozzle groups for ejecting multiple types of ink, and

a plurality of testing units for testing nozzle misfire in relation to the N print heads,

wherein testing units of the plurality of testing units are disposed at locations from which testing of all N print heads is not possible, but from which testing may be performed on at least one print head pre-assigned to the testing unit.

According to this printing device, nozzle testing in a plurality of print heads can be carried out accurately within a relatively brief time interval.

2. Printing device according to Aspect 1 further comprising a carriage having the N print heads disposed thereon, and reciprocating in a predetermined first direction,

wherein a plurality of print heads constituting at least some of the N print heads are disposed at mutually different locations in relation to a second direction perpendicular to the first direction,

the plurality of testing units disposed at mutually different locations in relation to the second direction.

3. Printing device according to Aspect 2 wherein

the N print heads are grouped in a plurality of print head arrays each including print heads disposed on a substantially straight line in the second direction, and a number N of nozzle groups provided to the N print heads for ejecting any given single type of ink are disposed at mutually different locations in the second direction,

the plurality of testing units including a number N of testing units each capable of testing the N nozzle groups.

4. Printing device according to any of Aspects 1 to 3 wherein

the plurality of testing units are equal in number to the number N of the print heads, each testing unit performing testing in relation to one print head.

5. Printing device according to any of Aspects 1 to 4 wherein

the plurality of testing units are grouped into first and second testing unit sets disposed outwardly from the two side edges of the print medium in relation to the first direction.

6. Nozzle test method for print heads, the method comprising the steps of

providing a number N (where N is an integer equal to 2 or greater) of print heads each having a plurality of nozzle groups for ejecting multiple types of ink,

providing a plurality of testing units for testing nozzle misfire in the N print heads, and

using testing units of the plurality of testing units to perform testing of at least one print head pre-assigned to the testing unit.

7. Method according to Aspect 6 wherein

the N print heads are disposed on a carriage that reciprocates in a predetermined first direction,

a plurality of print heads constituting at a minimum some section of the N print heads are disposed at mutually different locations in relation to a second direction perpendicular to the first direction, and

the plurality of testing units are disposed at mutually different locations in relation to the second direction.

8. Method according to Aspect 7 wherein

the N print heads are grouped in a plurality of print head arrays each including print heads disposed on a substantially straight line in the second direction, a number N of nozzle groups provided to the N print heads for ejecting any given single type of ink are disposed at mutually different locations in the second direction, and

the plurality of testing units include a number N of testing units each capable of testing the N nozzle groups

9. Method according to any of Aspects 6 to 8 wherein

the plurality of testing units are equal in number to the number N of the print heads, each testing unit performing testing in relation to one print head.

10. Method according to any of Aspects 6 to 9 wherein

the plurality of testing units are grouped into first and second testing unit sets disposed outwardly from the two side edges of the print medium in relation to the first direction.

11. Printing device comprising

a plurality of individually replaceable print head units each including a plurality of nozzle groups for ejecting multiple types of ink,

a cleaning section for performing nozzle cleaning of the plurality of print head units,

a timing table containing cleaning timing information that specifies execution timing of nozzle cleaning for each of the plurality of print head units, and

a controller for controlling operation of the cleaning section,

wherein the controller causes the cleaning section to execute nozzle cleaning for each of the plurality of print head units according to the cleaning timing information.

According to this printing device, even in the event that different times are required for cleaning of individual print head units requiring nozzle cleaning, nozzle cleaning may be carried out at appropriate timing for each unit.

12. Printing device according to Aspect 11 wherein

when any one print head unit is replaced, the controller updates the cleaning timing information relating to the print head unit.

13. Printing device according to Aspect 12 wherein

the controller updates the cleaning timing information relating to print head units depending on the service history of each print head unit.

14. Printing device according to Aspect 13 wherein

the controller updates the cleaning timing information contained in the timing table, in such a way that nozzle cleaning is performed at more frequent intervals for print head units installed in the printing device at earlier points in time.

15. Print head cleaning method, the method comprising the steps of

providing a plurality of individually replaceable print head units each including a plurality of nozzle groups for ejecting multiple types of ink, and

establishing cleaning timing information for specifying execution timing of nozzle cleaning for each of the plurality of print head units.

16. Method according to Aspect 15 further comprising the step of

when any one print head unit is replaced, updating the cleaning timing information relating to the print head unit.

17. Method according to Aspect 16 further comprising the step of

updating the cleaning timing information relating to print head units depending on the service history of each print head unit.

18. Method according to Aspect 17 wherein

the cleaning timing information is updated in such a way that nozzle cleaning is performed at more frequent intervals for print head units placed in service at earlier points in time.

19. Printing device for performing printing on a print medium, the device comprising

a number N (where N is an integer equal to 2 or greater) of print heads each having a plurality of nozzle groups for ejecting multiple types of ink, and

a testing unit for testing nozzle misfire with respect to the N print heads,

wherein the testing unit, with regard to a malfunctioning nozzle that has been concluded as a result of testing to be misfiring, generates malfunctioning nozzle information that includes the number of the malfunctioning nozzle within the nozzle group to which the malfunctioning nozzle belongs, the number of the nozzle group in the print head containing the nozzle group, and the identification number of the print head.

With this printing device, the location of a malfunctioning nozzle may be identified through malfunctioning nozzle information that includes three items of information, namely, nozzle number, nozzle group number, and the identification number of the print head.

20. Printing device according to Aspect 19 wherein

the print head identification number is an identification number uniquely assigned to the print head at the time of production of the print head.

21. Printing device according to Aspect 19 or 20 further comprising

a cleaning section for performing nozzle cleaning of the N print head units, and

a controller for controlling operation of the cleaning section,

wherein the controller selects, as a target for cleaning, the print head that includes the malfunctioning nozzle according to the malfunctioning nozzle information, and causes the cleaning section to perform the nozzle cleaning on the selected print head.

22. Nozzle testing method for print heads, the method comprising the steps of

providing a number N (where N is an integer equal to 2 or greater) of print heads each having a plurality of nozzle groups for ejecting multiple types of ink,

testing the N print heads for nozzle misfire, and

with regard to a malfunctioning nozzle that has been concluded as a result of the testing to be misfiring, generating malfunctioning nozzle information that includes the number of the malfunctioning nozzle within the nozzle group to which the malfunctioning nozzle belongs, the number of the nozzle group in the print head containing the nozzle group, and the identification number of the print head.

23. Method according to Aspect 22 wherein

the print head identification number is an identification number uniquely assigned to the print head at the time of production of the print head.

24. Method according to Aspect 22 or 23 further comprising the steps of

selecting, as a target for cleaning, the print head that includes the malfunctioning nozzle according to the malfunctioning nozzle information, and

performing nozzle cleaning on the selected print head.

25. Printing device comprising

a plurality of print heads each having a plurality of nozzle groups for ejecting multiple types of ink,

a cleaning section for performing nozzle cleaning of the plurality of print heads, and

a controller for controlling operation of the cleaning section,

wherein the controller selects one or more print heads as targets for the nozzle cleaning, and causes the cleaning section to perform nozzle cleaning simultaneously on all of the selected one or more print heads.

According to this printing device, cleaning of print heads targeted for nozzle cleaning may be carried out simultaneously, whereby cleaning may be performed efficiently within a short space of time.

26. Printing device according to Aspect 25 wherein

the nozzle cleaning includes nozzle suctioning, and

the controller can set the suction force level of the nozzle suctioning individually for each individual print head selected as a target for the nozzle cleaning.

27. Printing device according to Aspect 26 wherein

the controller can set the suction force level of the nozzle suctioning with reference to the service history of each individual print head selected as a target for the nozzle cleaning.

28. Print head cleaning method, the method comprising the steps of

providing a plurality of print heads each having a plurality of nozzle groups for ejecting multiple types of ink,

selecting one or more print heads as targets for nozzle cleaning, and

performing nozzle cleaning simultaneously on all of the selected one or more print heads.

29. Method according to Aspect 28 wherein

the nozzle cleaning includes nozzle suctioning, and

the suction force level of the nozzle suctioning is settable individually for each individual print head selected as a target for the nozzle cleaning.

30. Method according to Aspect 29 wherein

the suction force level of the nozzle suctioning is settable with reference to the service history of each individual print head selected as a target for the nozzle cleaning.

This invention may be embodied in various ways, for example, a printing method and printing device; a printing control method and printing control device; a nozzle cleaning method and device; a nozzle testing method and device; a computer program for realizing the functions of such methods or devices; a storage medium having such a computer program stored thereon; and a data signal containing such a computer program and embodied in a carrier wave.

### BRIEF DESCRIPTION OF THE DRAWINGS

FIG. 1 is an illustration showing the arrangement of a printer as an embodiment of the invention;

FIG. 2 is a simplified illustration of the printing section in the embodiment;

FIG. 3 is an illustration showing nozzle arrays on the lower face of a print head in the embodiment;

FIG. 4 is a simplified illustration of the carriage in the embodiment;

FIG. 5 is a simplified illustration of the carriage in the embodiment;

FIG. 6 is a simplified illustration of the printing section in the embodiment;

FIG. 7 illustrates print head ejection testing by the testing unit in the embodiment;

FIG. 8 is a simplified illustration of the cap section in the embodiment;

FIG. 9 is a conceptual illustration showing a part of the cap section arrangement in the embodiment;

FIG. 10 is a schematic illustration of a cleaning system employing the ink feed system and cap in the embodiment;

FIG. 11 is a flow chart showing a first type of suction cleaning as an embodiment;

FIG. 12 is a flow chart showing a second type of suction cleaning as an embodiment;

FIG. 13 is a flow chart showing a third type of suction cleaning as an embodiment;

FIG. 14 is a simplified illustration of a wiper section in the embodiment;

FIG. 15 is a perspective view of a wiper blade in the embodiment;

FIGS. 16(a) through 16(d) illustrates wiping of the lower face of a nozzle plate by a wiper blade in the embodiment;

FIG. 17 illustrates wiping of a print head on the carriage by the wiper section in the embodiment;

FIG. 18 is a perspective view showing the scheme of a wiper blade and cap composed as a single unit in the embodiment;

FIG. 19 is a block diagram showing the control circuit arrangement of the printer in the embodiment;

FIG. 20 is a flowchart showing a first sequence as an embodiment;

FIG. 21 is a flowchart showing a second sequence as an embodiment; and

FIG. 22 is a flowchart showing a timer cleaning sequence as an embodiment;

### BEST MODE FOR CARRYING OUT THE INVENTION

Modes for carrying out the invention are described hereinbelow through certain specific embodiments, in the following order.

A. Arrangement of the Device

B. Cleaning Sequence Embodiments

C. Variant Examples

### A. Arrangement of the Device

A1. Arrangement of Printer

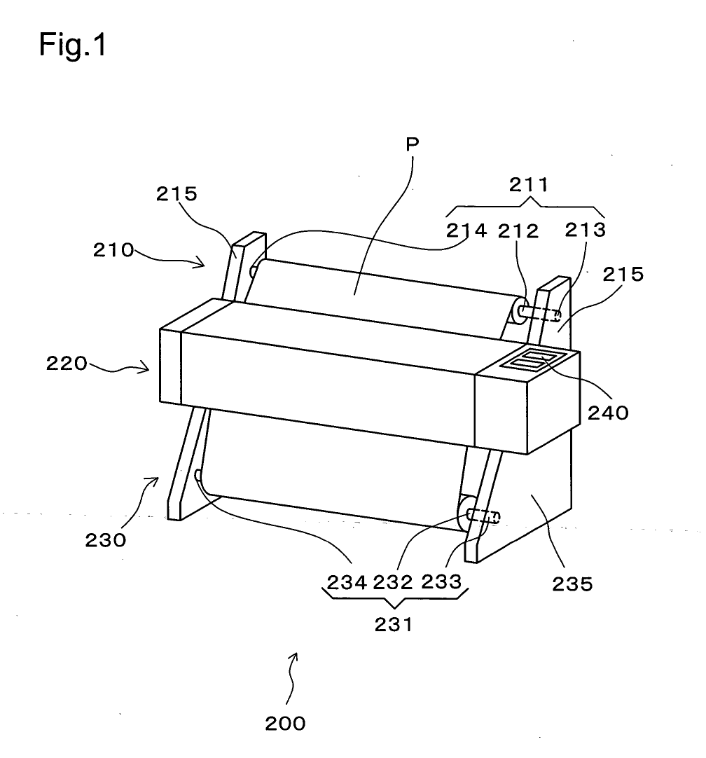

FIG. 1 is a simplified perspective view showing the arrangement of a printer 200 by way of an embodiment of the invention. Printer 200 is compatible with printer paper P of relatively large size, such as JIS A0 or B0 paper, or roll paper. Printer paper P is supplied to printing section 220 from a paper feed section 210. Printing section 220 performs printing by ejecting ink onto printer paper P supplied to it. Printer paper P printed in the printing section 220 is then discharged from a paper discharge section 230.

Paper feed section 210 comprises a roll paper holder 211 in which may be set printer paper P, which is roll paper. Roll paper holder 211 comprises a spindle 212 for holding the roll paper, and a first spindle support 213 and second spindle support 214 for detachably supporting spindle 212 so as to be suspended therebetween. The two spindle supports 213, 214 are disposed on two support posts 215 provided on the upper section of printer 200. Spindle 212 having a roll of paper installed in the center section thereof is then installed with its two ends mounted on first spindle support 213 and second spindle support 214.

Paper discharge section 230 comprises a wind-up holder 231 for winding up the roll paper. Wind-up holder 231 in turn comprises a wind-up spindle 232 for winding up roll paper that has been printed in printing section 220; and a first spindle support 233 and second spindle support 234 for detachably supporting spindle 232 so as to be suspended therebetween. The two spindle supports 233, 234 are disposed on two support posts 235 provided in the lower section of printer 200. Spindle 232 is installed with its two ends mounted on first spindle support 233 and second spindle support 234, so as to be rotatable by drive means, not shown. An arrangement whereby spindle 212 is rotated by drive means in order to wind up printer paper P is also possible. As will be described hereinbelow, a paper discharge roller or other paper feed means may be disposed within printing section 220, and the paper feed means driven in order to discharge paper printer P.

On the upper face of printing section 220 is disposed an input/output section 240 serving as an input section for inputting designation of a misfiring nozzle or cleaning target nozzle, printing mode, etc.

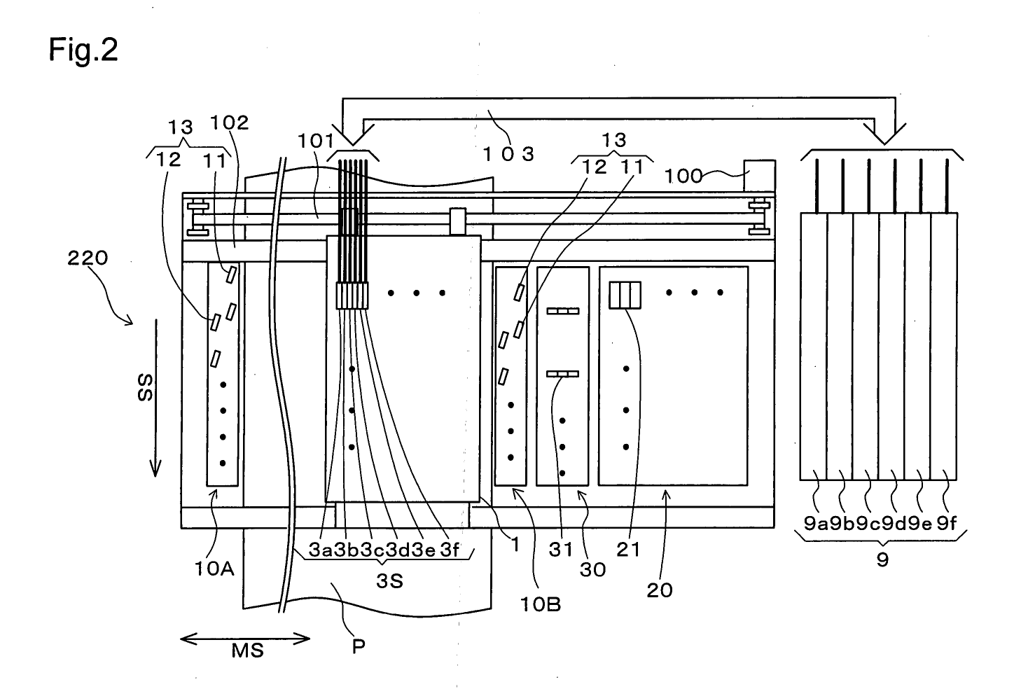

FIG. 2 is a simplified illustration of the arrangement of printing section 220. Printing section 220 has a carriage 1 with a plurality of print heads (described later) installed thereon. Also installed on carriage 1 are a plurality of sub-tank sets S3 for temporarily holding ink to be used by the print heads. One sub-tank set S3 includes a plurality of sub-tanks 3a-3f. Carriage 1 is coupled to a drive belt 101 which is driven by a carriage motor 100, so as to move in the main scanning direction MS guided by a main scan guide member 102. At the two edges of the printer paper P situated within the range or motion of carriage 1 in the main scanning direction are disposed a first testing section 10A and a second testing section 10B for testing ejection by the nozzles. To the side of the second testing section 10B are disposed a wiper section 30 for wiping nozzles, a cap section 20 for hermetically closing and cleaning nozzle groups, and a main tank set 9 for supplying ink to the sub-tank sets S3.

To perform printing, ink is ejected onto printer paper P from nozzles while moving carriage 1 in the main scanning direction to effect printing. To perform a nozzle ejection test, carriage 1 is moved to a position facing first testing section 10A or second testing section 10B, where a nozzle ejection test is performed. To perform wiping of nozzles, carriage 1 is moved to a position facing wiper section 30, where wiping is performed. To perform cleaning using a cap, carriage 1 is moved to a position facing cap section 20, where cleaning is performed.

Sub-tank sets S3 and main tank set 9 communicate via ink feed channels 103. In this embodiment, sub-tanks 3a-3f contain six different kinds of ink, namely, black K, cyan C, light cyan LC, magenta M, light magenta LM, and yellow Y, and are connected to six corresponding main tanks 9a-9f However, it should be noted that the number of inks used is not limited to six; it would be possible instead to use four kinds of ink (e.g. black K, cyan C, magenta M, and yellow Y) or seven kinds of ink (e.g. black K, light black LK, cyan C, light cyan LC, magenta M, light magenta LM, and yellow Y), for example. The number of kinds of ink used may be determined according to user preference.

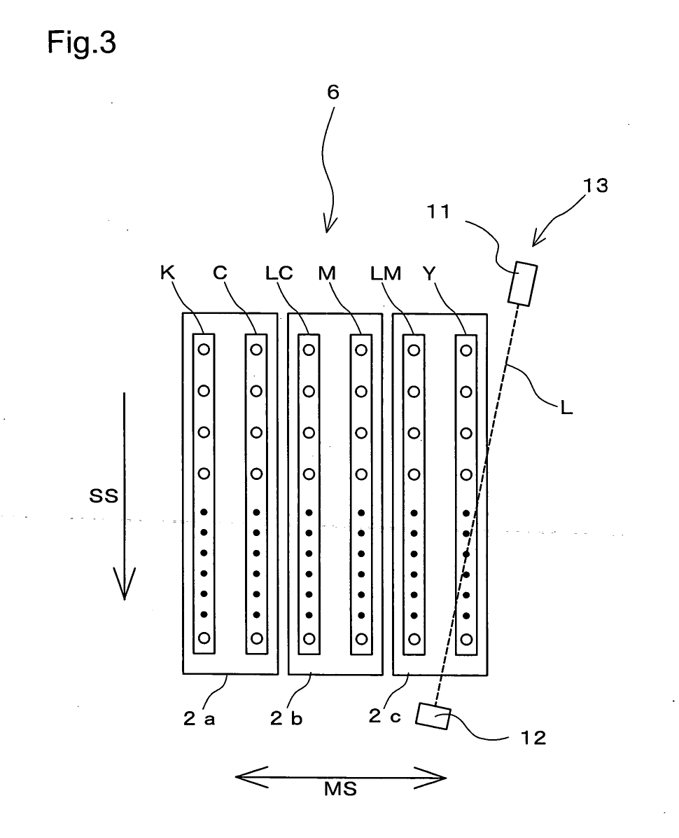

FIG. 3 is an illustration showing nozzle arrays on the lower face of one print head 6. Print head 6 has three nozzle plates 2a, 2b, 2c. On the lower face of each single nozzle plate are disposed two nozzle groups capable of ejecting different inks, so that print head 6 has a total of six nozzle groups. In this embodiment, a different ink is assigned to each nozzle group, but a given ink could instead by ejected from a number of nozzle groups. In this embodiment, each print head 6 is independently replaceable. That is, an assembly (also referred to herein as a “print head unit”) composed of a single print head 1 and a member (not shown) for fastening the print head 6 to the carriage can be replaced as a single unit.

A light emitter 11 and a light receiver 12 together constitute a test unit 13 for testing whether ink is being ejected normally from nozzles (hereinafter termed “ejection test”). First testing section 10A and a second testing section 10B are each provided with a plurality of such test units. These will be described in detail later.

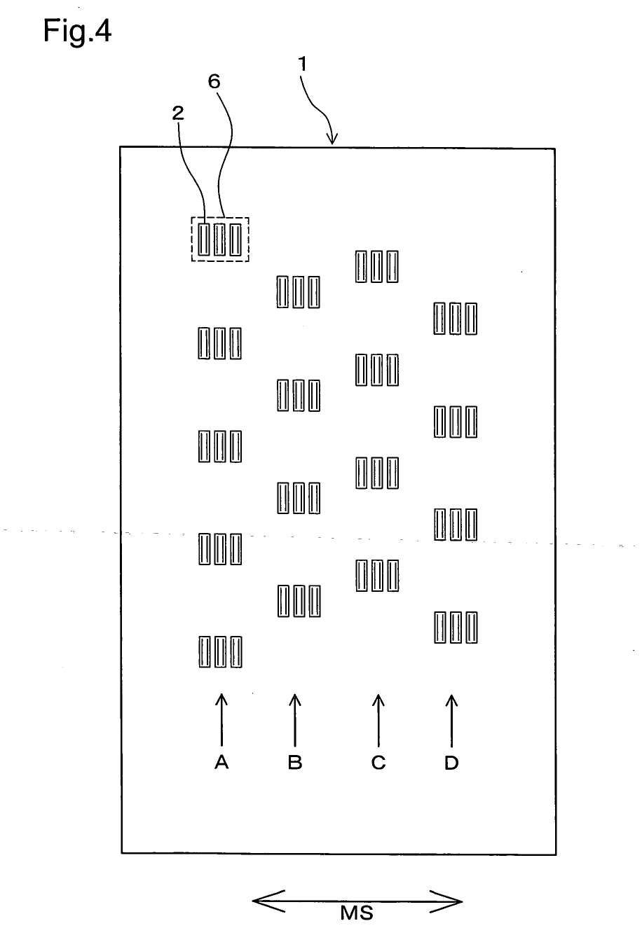

FIG. 4 is a simplified illustration of carriage 1. In this embodiment, a plurality of print heads 6 are installed on carriage 1. It is accordingly possible to print a relatively large area at one time, and to print at high speed even when relatively large printer paper is used.

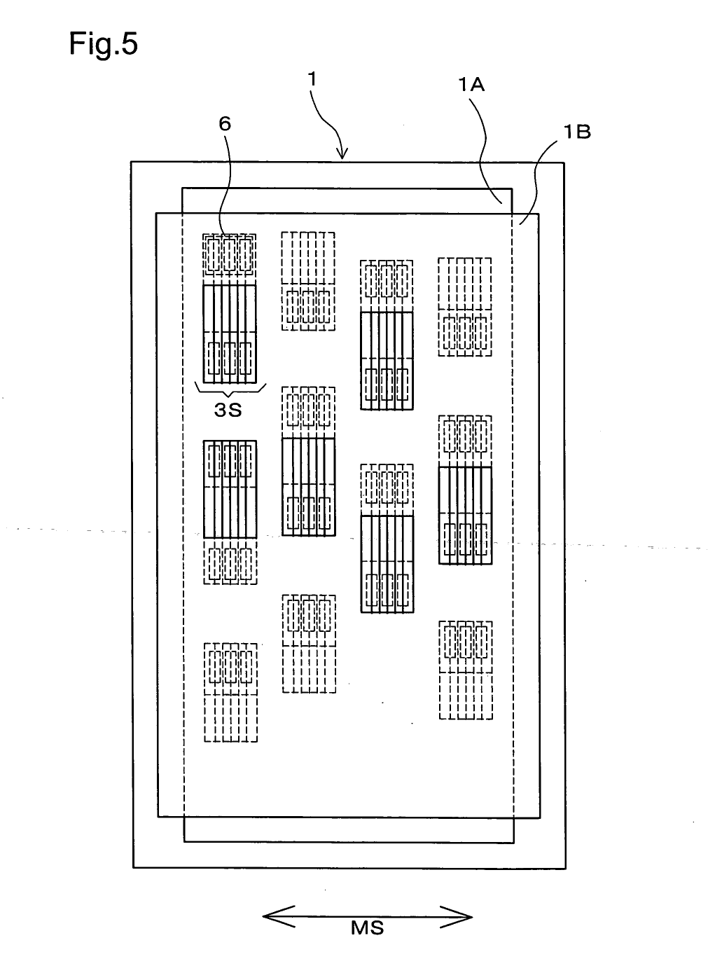

FIG. 5 is a simplified illustration of sub-tanks mounted on carriage 1. On carriage 1, one sub-tank set S3 is provided for each print head 6. In this embodiment, since not all of the sub-tank sets S3 can be disposed in a two-dimensional arrangement on carriage 1, sub-tank sets S3 are divided among two tiers of sub-tank plates 1A, 1B disposed on carriage 1. However, the number of plates is not limited to two; depending on the number of sub-tanks, a single tier or three or more tier plate arrangement may be employed.

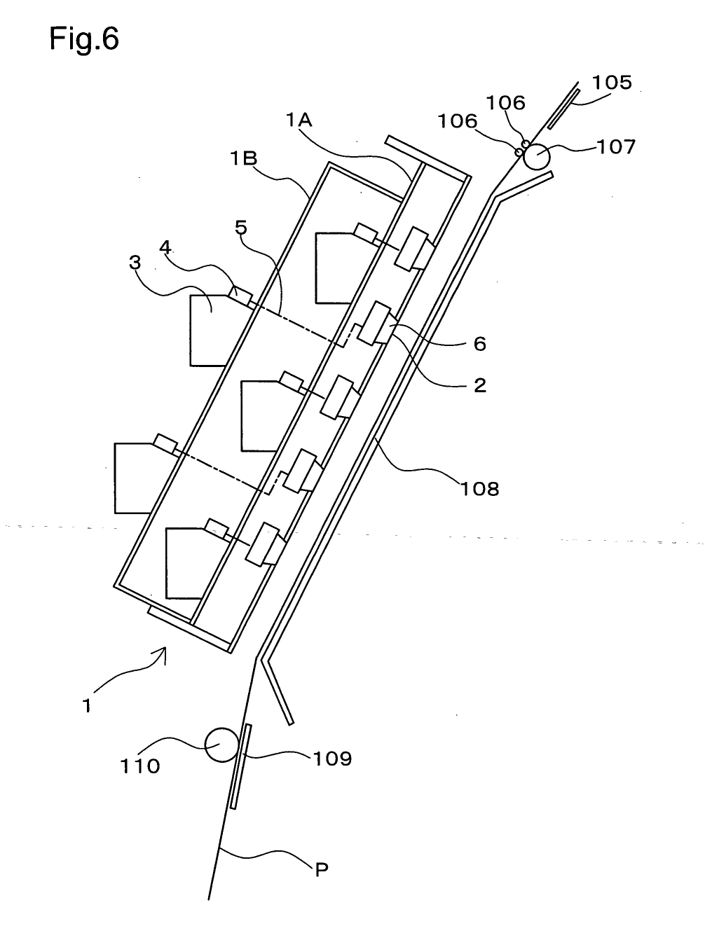

FIG. 6 is a fragmentary sectional view of printing section 220, including carriage 1. Printer paper P supplied by paper feed section 210 (FIG. 1) is printed as it passed through a printer paper feed path that extends from the upper rear of printer 200 (upper right in FIG. 6) to the lower front (lower left in FIG. 6), and is then discharged from paper discharge section 230.

Disposed on the printer paper feed path, in order from the paper feed section 210 end, are: a paper feed guide 105; a paper feed roller 106; a follower roller 107 arranged juxtaposed to paper feed roller 106; a printing stage 108 disposed on the diagonal; carriage 1 arranged juxtaposed to printing stage 108; a paper discharge guide 109; and a paper discharge roller 110 arranged juxtaposed to paper discharge guide 109.

Paper feed guide 105, printing stage 108, and paper discharge guide 109 have flat surfaces enabling them to functions as paper transport surfaces. Thus, as printer paper P is transported while flat, printed image distortion due to wrinkling of printer paper P can be prevented, even where relatively large sized paper is used.

A plurality of sub-tanks 3 are arranged on each of the two tier sub-tank plates 1A, 1B on carriage 1. Each sub-tank 3 has a valve 4 as opening/closing means. A sub-tank 3 is connected to a print head 6 by means of an ink feed passage 5 that passes through valve 4. In this embodiment, since a single print head 6 has six nozzle groups, six sub-tanks 3a-3f (FIG. 2) are connected to a single print head 6. Ink supply to each of the six nozzle groups of a single print head 6 can be halted individually through appropriate opening/closing of valves 4 for the nozzle groups.

Sub-tank 3 placement locations will be set such that the relationship between the height of a sub-tank 3 and the height of the corresponding nozzle plate is substantially the same regardless of the position of nozzle plates 2. By so doing, differences in head differential between sub-tanks 3 and nozzle plates 2 may be minimized. It is accordingly possible to minimize differences in ink ejection quantity due to differences in head differential, so as to produce consistent image quality. Sub-tank 3 placement locations may be such that fine adjustments can be made. In the event of deviation in ink ejection quantity from the print head, head differential can be adjusted by adjusting sub-tank 3 placement location, in order to adjust ink ejection quantity. Sub-tanks 3 and nozzle plates 2 may be attached to carriage 1 in the form of an integrated unit. This facilitates the procedure for replacing the sub-tanks 3 and nozzle plates 2.

A2. Arrangement of Testing Section

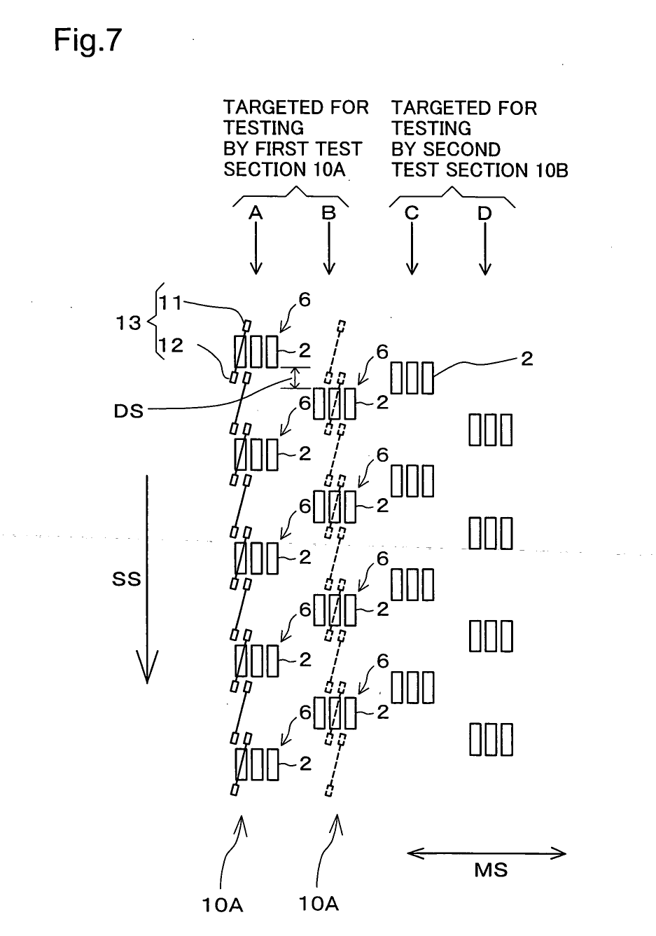

FIG. 7 illustrates the relationship between nozzle placement and placement of a plurality of test units 13 used by first testing section 10A. A single test unit 13 has a light emitter 11 and a light receiver 12. Light emitter 11 emits laser light L directed towards light receiver 12. Placement of light emitter 11 and light receiver 12 is such that the direction of the laser light L and the direction of nozzle arrays along the sub-scanning direction are somewhat slanted. During an ejection test, first, laser light L is directed towards light receiver 12 from light emitter 11. Next, as shown in FIG. 3, the print head is moved so that the path of ink ejected from the test target nozzle intersects laser light L, and ink is ejected from the test target nozzle. In the event that laser light L is blocked, it is determined that ink is being ejected.

As shown in FIG. 2, first testing section 10A and second testing section 10B are disposed to the outside at the two sides of printer paper P. FIG. 7 illustrates print head ejection testing by first testing section 10A. In this embodiment, first testing section 10A performs ejection testing of print heads 6 situated in row A and row B on the carriage, while second testing section 10B performs ejection testing of print heads 6 situated in row C and row D on the carriage. First testing section 10A has nine testing units 13 arranged along the sub-scanning direction. First testing section 10A can simultaneously test a plurality of nozzle plates 2 lined up in the sub-scanning direction on the carriage. By moving the carriage so that first testing section 10A is in the location represented by the solid lines, ejection testing can be performed on five print heads arranged in row A on the carriage. By moving the carriage so that first testing section 10A is in the location represented by the broken lines, ejection testing can be performed on four print heads arranged in row B on the carriage. In the same manner, ejection testing of row C and row D on the carriage can be carried out using second testing section 10B.

The arrangement in the sub-scanning direction of the print heads 6 in row A and the print heads 6 in row B is such that there is a gap DS permitting placement of light emitter 11 and light receiver 12. The arrangement in the sub-scanning direction of light emitting sections 11 and light receiving sections 12 of first testing section 10A is such that these elements are situated between, or to the outside of, the print heads 6 of row A and row B. Thus, light emitter 11 and light receiver 12 can perform ejection testing without interfering with the print heads. A similar relationship exists between the second testing section 10B and rows C and D, so that light emitter 11 and light receiver 12 can perform ejection testing without interfering with nozzle plates 2.

A3. Arrangement of Cap Section

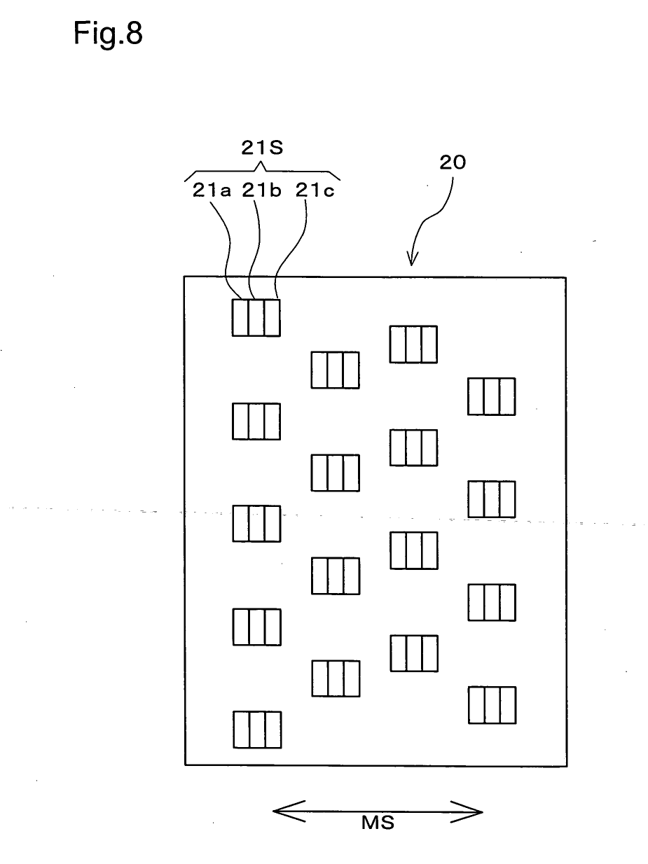

FIG. 8 is an illustration of a cap set 21S on cap section 20. In this embodiment, one cap set 21S corresponds to one print head 6 (FIG. 7), and has three caps 21a, 21b, 21c corresponding to the three nozzle plates 2a, 2b, 2c (FIG. 3). Accordingly, a single cap is provided for two nozzle groups. Alternatively, a single cap could be provided for a single print head 6, or a single cap could be provided for a single nozzle group.

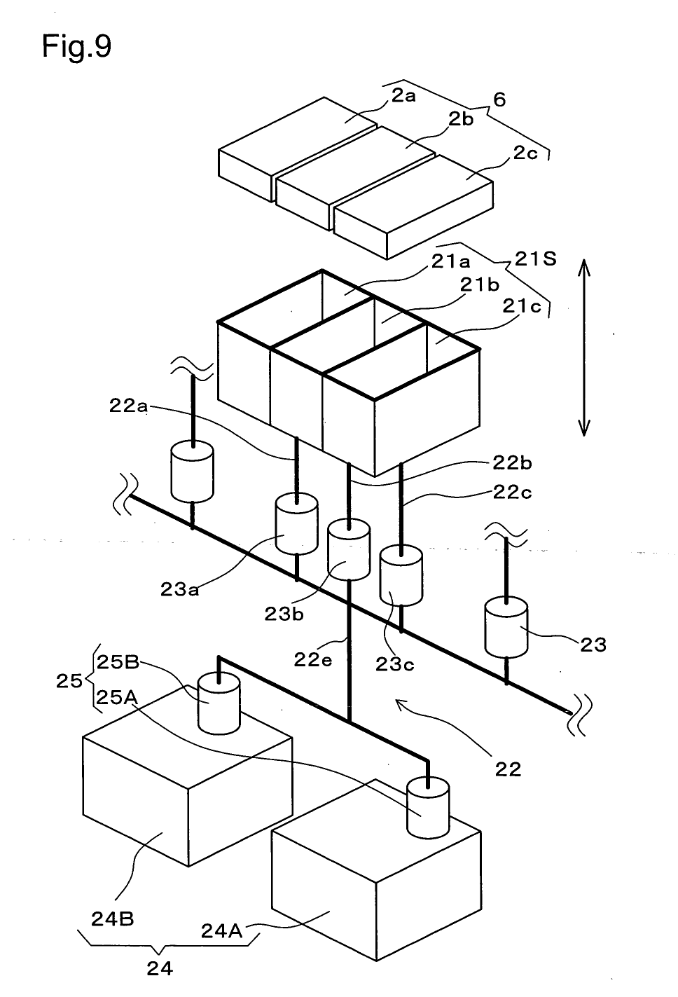

FIG. 9 is a conceptual illustration showing a part of the arrangement of cap section 20. Caps 21a, 21b, 21c are each connected to suctioning passages 22a, 22b, 22c equipped respectively with valves 23a, 23b, 23c as first opening/closing means. Suctioning passages 22a, 22b, 22c in turn connect to a suctioning section 24. In this embodiment, suctioning section 24 is composed of a first pump 24A having a relatively high level of suction force, and a second pump 24B having a relatively low level of suction force. The pumps are connected by means of valves 25A, 25B, respectively, as third opening/closing means. By selectively opening and closing valve 25A and valve 25B, first pump 24A and second pump 24B can be selectively operated. The suctioning passage 22 leading from valves 23a, 23b, 23c to suctioning section 24 consists in part of a common suctioning passage 22e.

Cap set 21S is driven by a drive mechanism, not shown, to move it towards a print head 6, where it intimately contacts the lower face of the print head to form a hermetic space covering the nozzle groups. The suctioning section 24 is then actuated to suction out the gas from the hermetic space, causing the pressure within the hermetic space to drop so that ink can be forcibly suctioned out from the nozzles. The suctioned ink is discharged via suctioning passage 22 to a waste ink discharge section, not shown.

The suctioning section 24 of this embodiment may be composed, for example, of suction pump or roller pump. The use of a roller pump, which has a simple construction, provides easy maintenance of the suctioning section. Suctioning means having a variable level of suction force may also be used. By so doing, suctioning at an appropriate level of suction force for each type of cleaning operation can be provided without using valves 25.

When printing is not being performed, cap section 20 can be positioned with cap set 21S in intimate contact with the lower face of the print head and with valves 23 closed, to prevent drying out of the nozzles.

In this embodiment, there are provided a plurality of cap sets 21S (FIG. 8) for simultaneously covering all of the print heads 6 (FIG. 7) on the carriage, and simultaneous cleaning of all print heads 6 is possible. However, cap sets 21S could instead be provided in a number fewer than the number of print heads 6, and a plurality of cleaning operations performed by moving cap sets 21S and/or print heads 6 in order to perform cleaning of all print heads 6. This would allow for a more compact device.

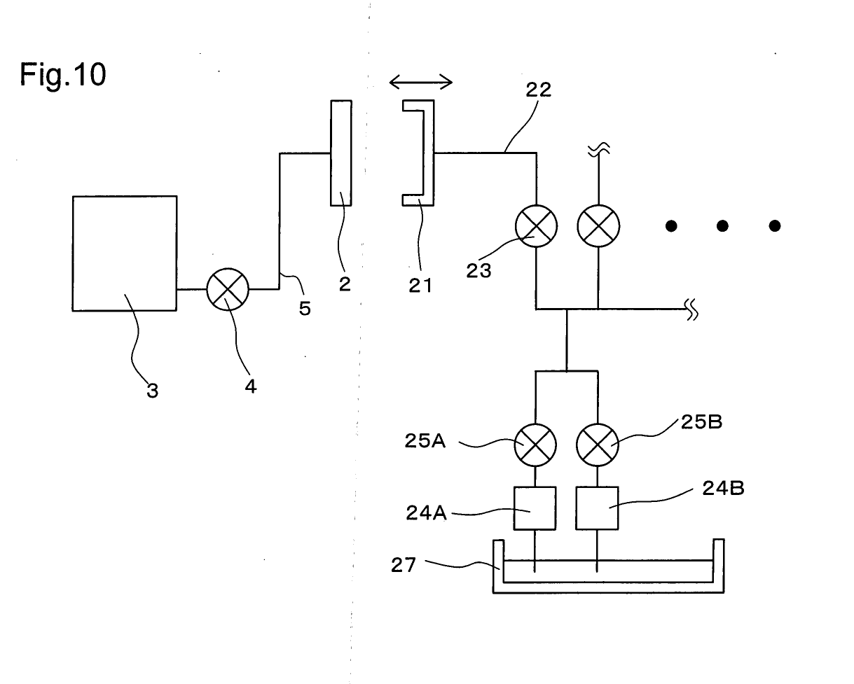

FIG. 10 is a schematic illustration of a cleaning system employing the ink feed system and cap in the embodiment. For convenience in illustration, FIG. 10 shows the arrangement of a cleaning system for a single nozzle plate 2 which ejects one kind of ink. This cleaning system can perform the following several types of cleaning operations.

(1) First Type of Suction Cleaning

Ink is suctioned from nozzles at a normal level of suction pressure.

(2) Second Type of Suction Cleaning

Utilizing opening/closing operations of valve 23 on the suctioning passage, ink is suctioned rapidly from nozzles.

(3) Third Type of Suction Cleaning

Utilizing opening/closing operations of valve 4 on ink feed passage 5, ink is suctioned rapidly from nozzles.

A description of the sequence for filling the sub-tank 3 with ink when performing cleaning will be omitted from the description hereinbelow. Ink fill levels in sub-tanks may be sensed by means of sensors that employ some combination of a Hall element, magnetic body, float mechanism or the like.

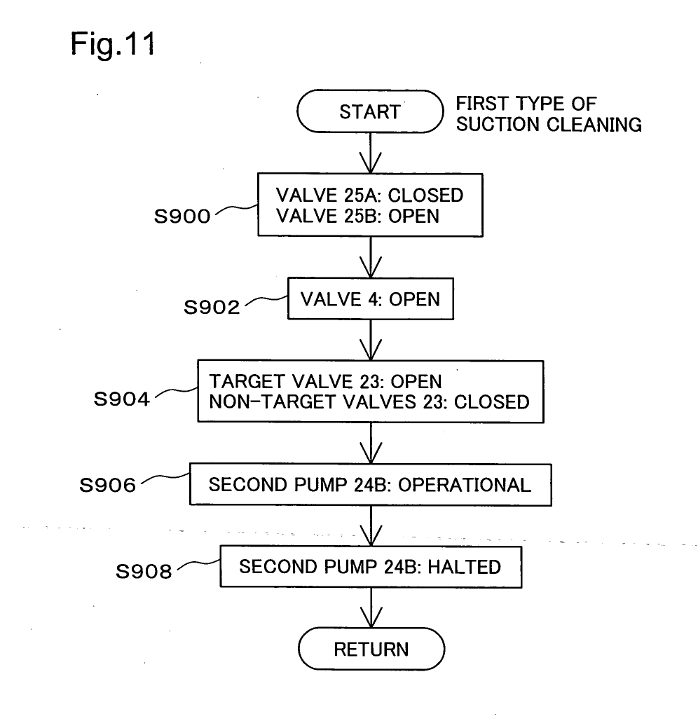

FIG. 11 is a flow chart showing a first type of suction cleaning. When performing a suction cleaning operation of the first type, either the first pump 24A or the second pump 24B is used. Here, a case where the second pump 24B having a relatively low level of suction force is used will be described. First, in Step S900, valve 25A is closed and valve 25B is opened. Next, in Step S902, valve 4 (provided as the second opening/closing means on ink feed passage 5) is placed in the open position. Valves 4 other than the valve 4 corresponding to the nozzle group targeted for cleaning may be closed. Next, the routine proceeds to Step S904, wherein, of the several valves 23, only the valve 23 that is connected to the cap 21 corresponding to the nozzle groups targeted for cleaning is opened; then moving to Step S906, second pump 24B is actuated. Thereupon second pump 24B suctions out gas exclusively from the hermetic space situated beneath the cap 21 whose associated valve 23 is open, thereby suctioning out ink from the nozzles. As a result, foreign matter or highly viscous ink which has caused nozzle misfire is suctioned out, thereby resolving the cause of misfire. The suctioned ink or other material is discharged to a waste ink discharge section 27.

In this way, in suction cleaning operation of the first type, forcible suctioning of ink is performed for the cap associated with a nozzle group that has been targeted for cleaning, so that suctioning of ink from nozzle groups not targeted for cleaning can be prevented. As a result, a smaller amount of ink is discarded during cleaning operations. While the timing for pump operation and pump actuation may be determined arbitrarily, in preferred practice, the pump will be actuated after valve operation has been completed. By so doing, it is possible to prevent excessive suctioning of ink. Where suctioning has been carried out at a relatively low level of suction force, the ink surface in proximity to the nozzle opening (termed a meniscus) can consistently return to its preferred shape upon completing of cleaning. Where suctioning has been carried out at a relatively high level of suction force, on the other hand, ability to expel foreign matter, air bubbles, or the like is enhanced.

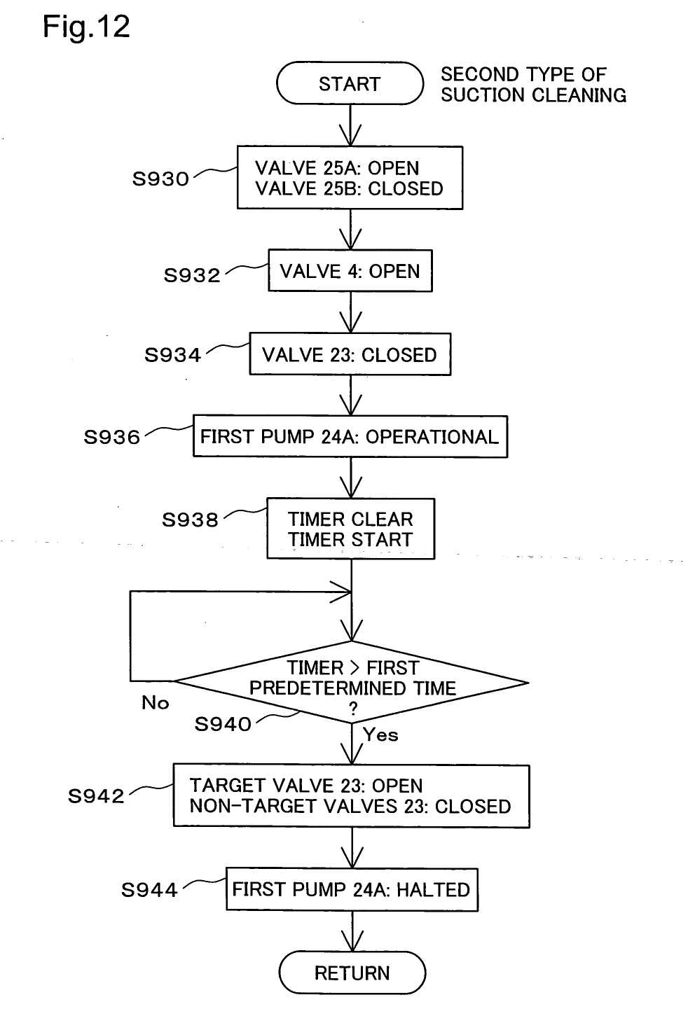

FIG. 12 is a flow chart showing a second type of suction cleaning. When performing a suction cleaning operation of the second type, either the first pump 24A or the second pump 24B is used. Here, a case where the first pump 24A having a relatively high level of suction force is used will be described. First, in Step S930, valve 25A is opened and valve 25B is closed. Next, in Step S932, valve 4 (provided as the second opening/closing means on ink feed passage 5) is placed in the open position. Valves 4 other than the valve 4 corresponding to the nozzle group targeted for cleaning may be closed. Next, the routine proceeds to Step S934, wherein all of the valves 23 provided on suctioning passage 22 are initially placed in the closed position. In this state, proceeding to Step S936, first pump 24A is actuated. After first pump 24A has been actuated, in Step S938, measurement of elapsed time by a timer 68 commences. In Step S940, elapsed time measured by timer 68 is compared with a first predetermined time interval, and in the event that elapsed time has not yet exceeded the first predetermined time interval, the routine goes back to Step S940. Step S940 is repeated for as long as elapsed time is shorter than the first predetermined time interval. During this time, gas is suctioned out from the suctioning passage extending between first pump 24A and valve 23, lowering the pressure. In the event that elapsed time now exceeds the first predetermined time interval, the routine proceeds to Step S942 in which the valve 23 corresponding to the nozzle group targeted for cleaning is opened. Thereupon, a sharp drop in pressure in the hermetic space is produced exclusively for the cap 21 whose associated valve 23 is open, so that ink is rapidly suctioned from the nozzles. As a result, foreign matter or highly viscous ink which has caused nozzle misfire is suctioned out, thereby resolving the cause of misfire. The suctioned ink or other material is discharged to a waste ink discharge section 27.

Compared to suction cleaning of the first type, suction cleaning of the second type involves rapid forcible suctioning of ink, and is thus able to resolve misfires that are difficult to resolve with cleaning of the first type. While the timing for pump operation and pump actuation may be determined arbitrarily according to ease of operation, in preferred practice, the pump will be actuated after all valves 23 have been closed. By so doing, it is possible to prevent excessive suctioning of ink.

The first predetermined time interval used in performing suction cleaning operations of the second type may be from 1 second to 10 seconds, preferably from 2 to 7 seconds, where the level of suction force by the suctioning section is about −20 kPa to −60 kPa (−0.2 atm to −0.6 atm). By so doing it is possible to create a sufficient pressure drop within the hermetic space so that misfires can be resolved within a brief time period. In preferred practice, the first predetermined time interval will be determined with reference to hermetic space and suctioning passage capacity, and to suctioning section capabilities.

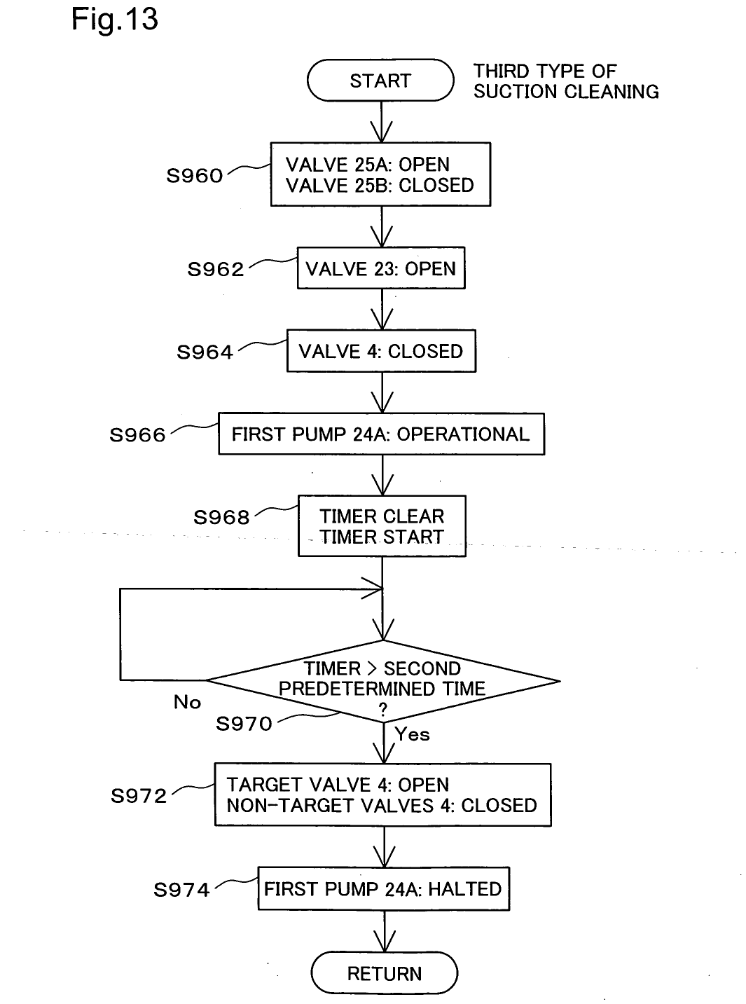

FIG. 13 is a flow chart showing a third type of suction cleaning. When performing a suction cleaning operation of the third type, either the first pump 24A or the second pump 24B is used. Here, a case where the first pump 24A having a relatively high level of suction force is used will be described. First, in Step S930, valve 25A is opened and valve 25B is closed. Next, in Step S962, valve 23 situated in suctioning passage 22 is placed in the open position. Valves 23 other than the valve 23 corresponding to the nozzle group targeted for cleaning may be closed. Next, the routine proceeds to Step S964, wherein all of the valves 4 provided as second opening/closing means on ink feed passage 5 are initially placed in the closed position. In this state, proceeding to Step S966, first pump 24A is actuated. After first pump 24A has been actuated, in Step S968, measurement of elapsed time by a timer 68 commences. In Step S970, elapsed time measured by timer 68 is compared with a second predetermined time interval, and in the event that elapsed time has not yet exceeded the second predetermined time interval, the routine goes back to Step S970. Step S970 is repeated for as long as elapsed time is shorter than the second predetermined time interval. During this time, gas is suctioned out from the hermetic space formed by the cap 21, lowering the pressure. In the event that elapsed time now exceeds the second predetermined time interval, the routine proceeds to Step S972 in which the valve 4 corresponding to the nozzle group targeted for cleaning is opened. Thereupon, ink is rapidly suctioned from the nozzles, exclusively for the cap 21 whose associated valve 4 is open. As a result, foreign matter or highly viscous ink which has caused nozzle misfire is suctioned out, thereby resolving the cause of misfire. The suctioned ink or other material is discharged to a waste ink discharge section 27.

Compared to suction cleaning of the first type, suction cleaning of the third type involves rapid forcible suctioning of ink, and is thus able to resolve misfires that are difficult to resolve with cleaning of the first type. Compared to suction cleaning of the second type, suction cleaning of the third type affords more efficient suctioning of ink, due to a greater depressurized volume including the space within the cap prior to suctioning of the ink. While the timing for pump operation and pump actuation may be determined arbitrarily according to ease of operation, in preferred practice, the pump will be actuated after all valves 4 have been closed. By so doing, it is possible to prevent excessive suctioning of ink.

The second predetermined time interval used in performing suction cleaning operations of the third type may be from 1 second to 10 seconds, preferably from 2 to 7 seconds, where the level of suction force by the suctioning section is about −20 kPa to −60 kPa (−0.2 atm to −0.6 atm). By so doing it is possible to create a sufficient pressure drop within the hermetic space so that misfires can be resolved within a brief time period. In preferred practice, the second predetermined time interval will be determined with reference to hermetic space and suctioning passage capacity, and to suctioning section capabilities.

Cleaning operations of the second and third type, by virtue of employing relatively high levels of suctioning force as described hereinabove, are superior to cleaning at a relatively low level of pressure in that higher discharge capabilities are achieved for the same required cleaning sequence time.

A suctioning section having variable suction force level may be employed as the suctioning section. In this case, suctioning force will preferably be adjusted to a level appropriate for the type of cleaning. Alternatively, a single kind of suctioning section may be employed regardless of the type of cleaning. This holds down the cost of the suctioning section.

Suctioning force provided during suction cleaning may be set to the same value for all print heads (or all nozzle groups) that will be targeted for cleaning; or set on an individual basis to different levels on a print head-by-print head (or nozzle group-by-nozzle group) basis. In the case of the latter arrangement, suction force for each print head will be determined, for example, with reference to the type of ink used by the print head, service history of the print head, and so on.

As the print head targeted for cleaning, there is selected, for example, a print head containing a nozzle that has been determined to be misfiring (malfunctioning nozzle) through testing by testing section 13 (FIG. 7). The location of the malfunctioning nozzle is identified through the number of the malfunctioning nozzle within the nozzle group to which the malfunctioning nozzle belongs, the number of the nozzle group in the print head containing that nozzle group, and the identification number of the print head. The print head identification number may be a number determined from the location of the print head within the printer, or an identification number uniquely assigned to the print head at the time of production of the print head.

From the results of ejection testing, control circuit 40 is able to generate malfunctioning nozzle information that includes the nozzle number of the malfunctioning nozzle, the nozzle group number, and the print head identification number, and to select a print head targeted for cleaning, in response to this malfunctioning nozzle information. Where cumulative malfunctioning nozzle information is stored in memory, this malfunctioning nozzle information can be utilized to identify nozzles/nozzle groups/print heads prone to malfunctioning. For example, it is possible to obtain information relating to quality in production processes from this malfunctioning nozzle information and an identification number uniquely assigned to a print head at the time of production of the print head.

A4. Arrangement of Wiper Section

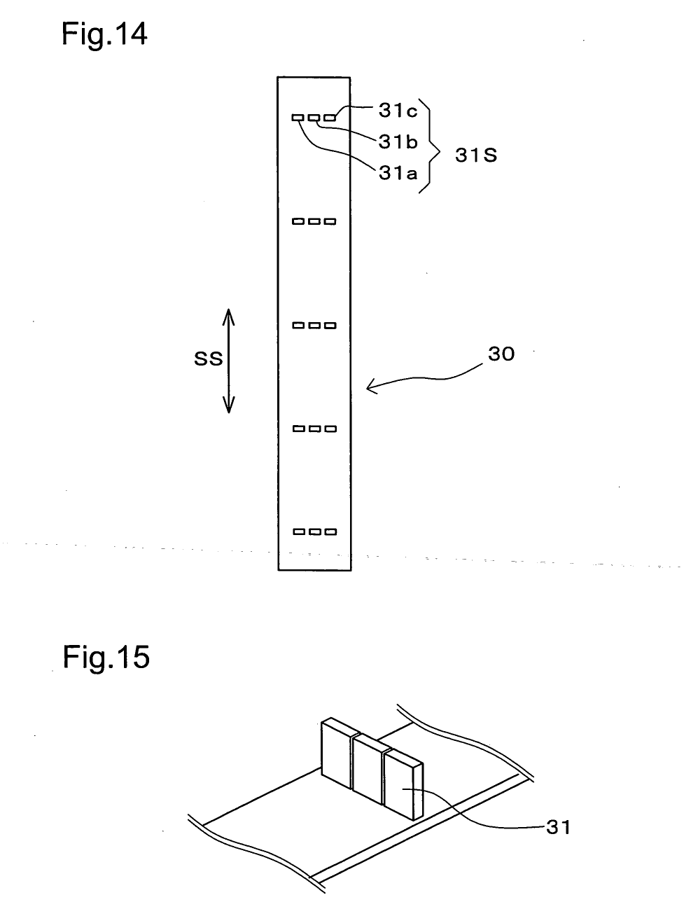

FIG. 14 is an illustration of the arrangement of wiper section 30 (FIG. 2). Wiper section 30 comprises wiper blade sets 31S each composed of three wiper blades 31a, 31b, 31c; five such sets are arranged in a row in the sub-scanning direction.

FIG. 15 is a perspective view of a wiper blade 31. Wiper blade 31 is constructed of a resilient element of rubber shaped into tabular form and to dimensions adequate for wiping a single nozzle plate. However, a single wiper blade 31 is not limited to a one-to-one associated with a single nozzle plate, and could instead be designed to be associated with several nozzle groups, or with several print heads, for example. For example, an arrangement whereby a single wiper blade 31 simultaneously wipes three nozzle plates 2a, 2b, 2c is possible.

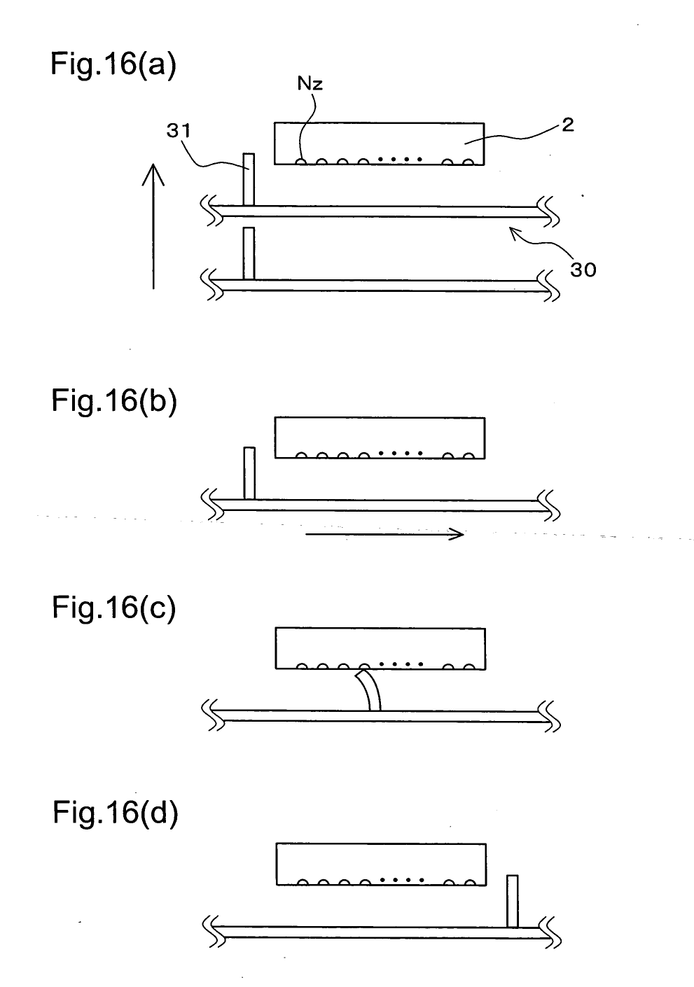

FIG. 16 illustrates wiping of the lower face of a nozzle plate 2 by wiper blade 31, showing the wiper section 30 in side view. A plurality of nozzles Nz are arrayed in the sub-scanning direction on the lower face of nozzle plate 2. From a position offset in the sub-scanning direction from the nozzle group targeted for cleaning and away from the plane containing the nozzles (indicated by the dotted lines in FIG. 12(a)), wiper section 30, still in the offset state, moves closer to the nozzle group at a position indicated by the solid lines in FIG. 12(a) (first operation). By subsequently moving in the sub-scanning direction in the order shown in FIGS. 12(b), (c) and (d) (second operation), wiping of the lower face of the nozzle plate 2 is performed. Thus, paper fragments, ink residue and the like adhering to the lower face of nozzle plate 2 can be removed, so that misfire can be resolved.

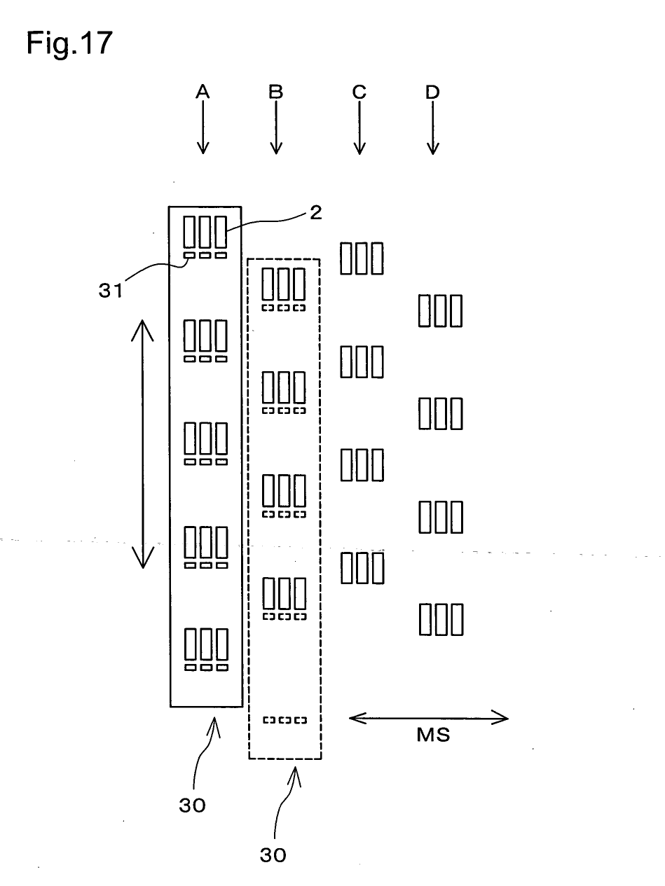

FIG. 17 illustrates wiping of nozzle plates 2 on the carriage by wiper section 30. Wiper section 30 can simultaneously wipe a plurality of nozzle plates 2 lined up in the sub-scanning direction on the carriage. The carriage is moved so that wiper section 30 is located at the position indicated by the solid lines, and the wiper section 30 is then moved upwardly so that wiping of nozzle plates 2 arranged in row A on the carriage can be performed. By subsequently moving the carriage so that wiper section 30 is now located at the position indicated by the broken lines, wiping of nozzle plates 2 arranged in row B on the carriage can be performed. Wiping of nozzle plates 2 arranged in rows C and D on the carriage is performed is a similar manner.

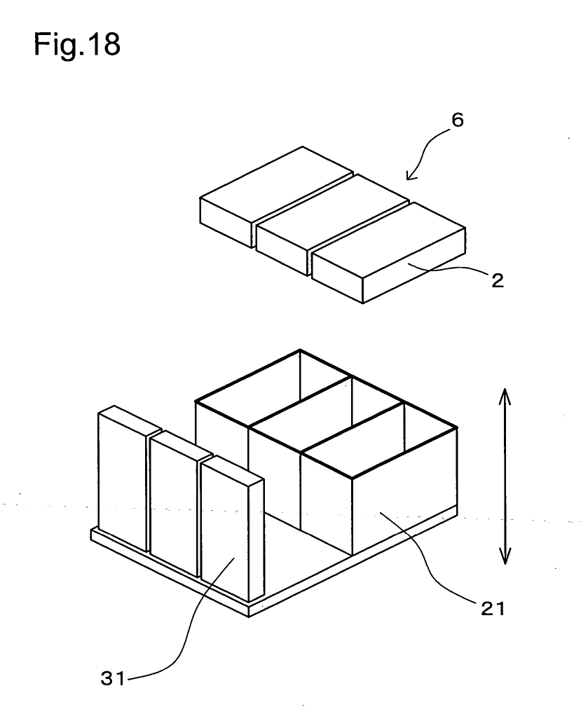

Wiper blade 31 and the cap can be constructed as a single unit. FIG. 18 is a perspective view showing the scheme of a wiper blade and cap composed as a single unit. Three sets that each include a wiper blade 31 and a cap 21 are provided in association with a single print head 6. Wiper blade 31 and cap 21 are not limited to association with a single nozzle plate 2; these may be provided in association with a single nozzle group, or in association with a plurality of print heads.

A6. Arrangement of Controller

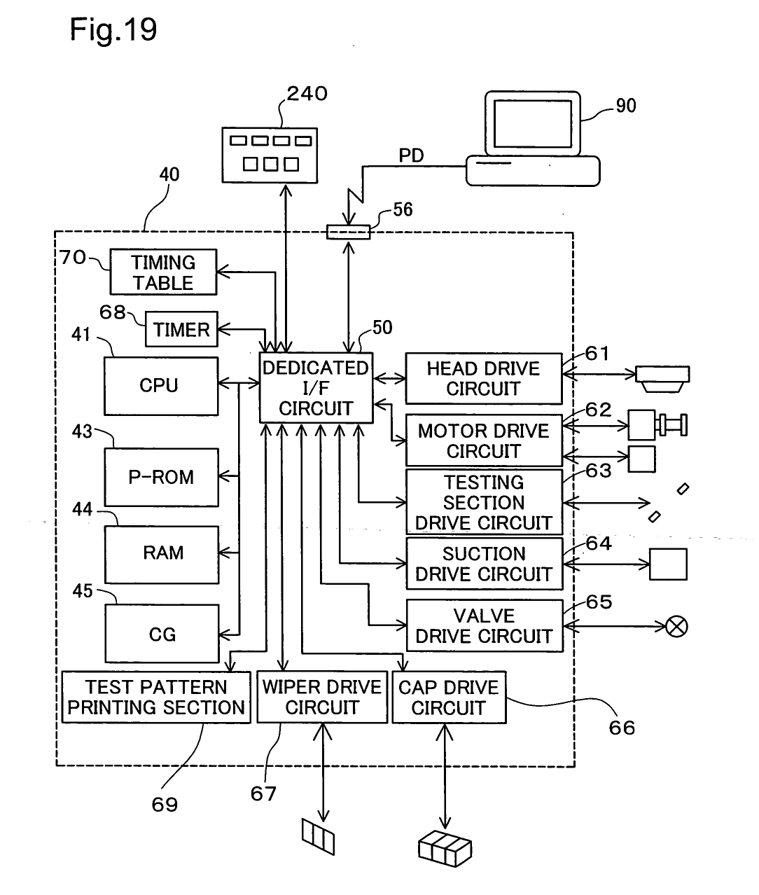

FIG. 19 is a block diagram showing the arrangement of printer 200, centering on the control circuit 40 which is the controller. This printing system comprises a computer 90 as the printing control device. Printer 200 and computer 90 may be collectively termed a “printing device” in the broad sense.

Control circuit 40 is configured as an arithmetic-logic circuit comprising a CPU 41, programmable ROM (PROM) 43, RAM 44, and a character generator (CG) 45 storing character dot matrices. The control circuit 40 additionally comprises a dedicated I/F circuit 50 for dedicated interface with an external monitor or the like. This I/F circuit 50 is connected to: a head drive circuit 61 for driving print head 6 to eject ink from nozzle plates 2; a motor drive circuit 62 for driving the paper feed motor and carriage motor 100; a testing section drive circuit 63 for driving first testing section 10A and second testing section 10B; a suctioning section drive circuit 64 for driving the suctioning section; a valve drive circuit 65 for driving the valves; a cap drive circuit 66 for driving cap section 20; a wiper drive circuit 67 for driving wiper section 30; a timer 68; a timing table 70 that stores timing information stipulating timing for nozzle cleaning operations; a test pattern printing section 69 that stores a test pattern; and an input/output section 240.

I/F circuit 50 houses a parallel interface circuit, and can receive print data PD supplied by computer 90 via a connector 56. Circuitry in I/F circuit 50 is not limited to a parallel interface circuit; a universal serial bus interface circuit or other circuit could be selected for ease of connection to computer 90. Printer 200 executes printing according to this print data PD. RAM 44 functions as a buffer memory for temporary storage of print data PD.

Printer 200 can print a test pattern for the purpose of detecting nozzle misfire. Test pattern printing is performed on-demand according to a user instruction from input/output section 240 or an instruction from computer 90. If printed results reveal that misfire is occurring, the user may indicate the misfiring nozzle through input/output section 240. Information so indicated is not limited to the malfunctioning nozzle: an arrangement wherein a group composed of a plurality of nozzles and including the malfunctioning nozzle, such as a nozzle group, print head, print head unit or the like, is indicated is also possible.

By carrying out ejection testing using a test pattern, and/or ejection testing using the testing sections (10A, 10B), it is possible for control circuit 40 to ascertain a misfiring nozzle. Control circuit 40, on the basis of the misfiring nozzle ascertained thereby, can select a target nozzle group for cleaning. It is possible to select as the target for cleaning only the nozzle group that includes the misfiring nozzle, or to select as targets for cleaning some certain nozzle groups that include both the misfiring nozzle and normally functioning nozzles (some nozzle groups which do not constitute all of the nozzle groups on carriage 1). By so doing, cleaning can be carried out efficiently. In order to prevent misfire before it occurs, all nozzle groups could be selected as targets for cleaning.

In the event that a misfiring nozzle has been discovered, or the time for a periodic cleaning cycle has arrived, control circuit 40 appropriately actuates the drive circuits for performing cleaning of the print heads, i.e. the head drive circuit 61, cap drive circuit 66, etc., in order to perform cleaning of the print heads. Control circuit 40 can determine a cleaning sequence with reference to at least one parameter selected from ink refill schedule, ink tank replacement schedule, time elapsed since last printing operation, and ink type. For example, where cleaning is performed with reference to elapsed time, control circuit 40 will determine cleaning timing on the basis of timing information stored in timing table 70. “Timing information” herein refers to information for determining the timing at which to carry out cleaning. Timing information may consist, for example, of a time interval setting for carrying out cleaning.

In preferred practice, timing information in timing table 70 will be updated for each individual print head unit. For example, control circuit 40 may update the timing information for a single print head unit at the time that the print head unit is replaced. Also, in preferred practice, timing information will be set such that nozzle cleaning is performed at shorter time intervals for print head units installed in the printer at earlier points in time. Typically, the longer the time for which a print head unit has been installed in a printer, the more prone to nozzle misfire the print head unit tends to become. Accordingly, by updating timing information on a print head unit-by-print head unit basis with reference to service history of individual print head units, nozzle misfire can be tested for more efficiently. Selection of cleaning sequence and of a nozzle group and print head targeted for cleaning is described hereinbelow.

### B. Cleaning Sequence Embodiments

B1. Cleaning Sequence Embodiment 1

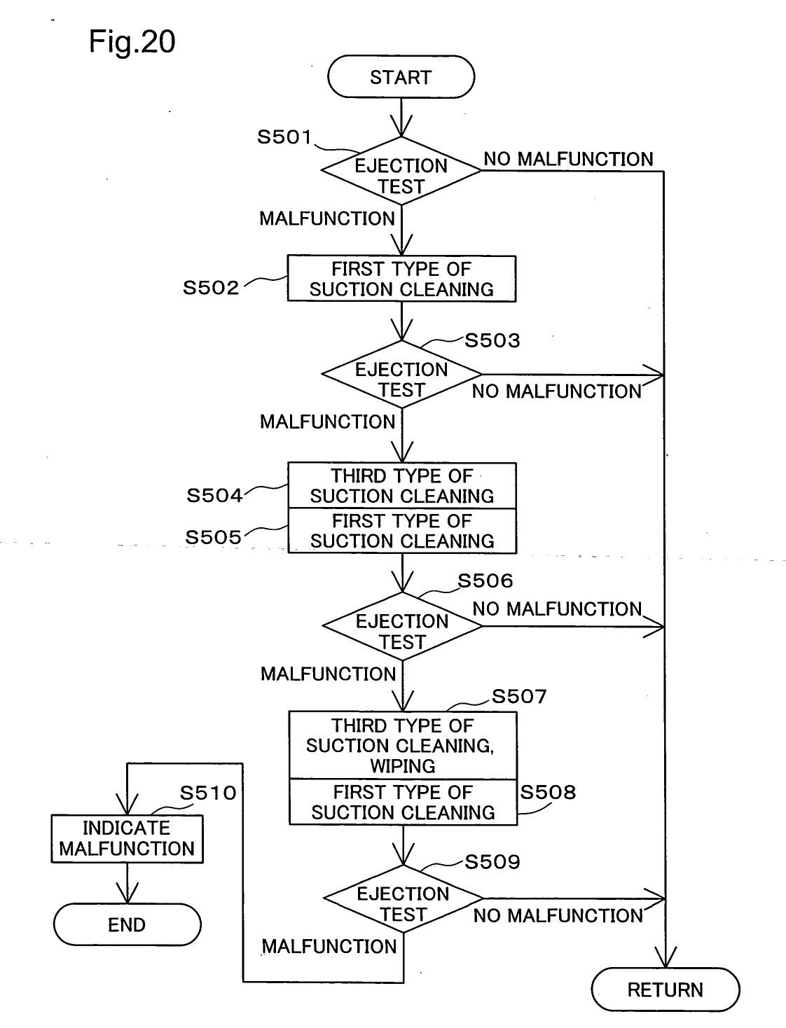

FIG. 20 is a flowchart showing a first sequence as an embodiment of a sequence for performing cleaning of a nozzle group. First, in Step S501, ejection testing of nozzles is carried out by first testing section 10A and second testing section 10B. In the event that no misfire is detected, the sequence terminates. In the event that misfire is detected, the nozzle group of the misfiring print head is selected as a target for cleaning, and the routine proceeds to Step S502.

In Step S502, the first type of suction cleaning described above (FIG. 11) is performed. Next, in Step S503, ejection testing is performed again. In the event that misfire has been resolved, the sequence terminates. In the event that misfire has not been resolved, the nozzle group of the misfiring print head is selected as a target for cleaning, and the routine proceeds to Step S504.

In Step S504, the third type of suction cleaning described above is performed, and then moving to Step S505, the first type of suction cleaning is performed. Next, in Step S506, ejection testing is performed again. In the event that misfire has been resolved, the sequence terminates. In the event that misfire has not been resolved, the nozzle group of the misfiring print head is selected as a target for cleaning, and the routine proceeds to Step S507.

In Step S507, a combination of the third type of suction cleaning described above and wiping as described above is performed, and then moving to Step S508, the first type of suction cleaning is performed. Next, in Step S509, ejection testing is performed again. In the event that misfire has been resolved, the sequence terminates. In the event that misfire has not been resolved, the routine proceeds to Step S510. In Step S510, input/output section 240 indicates a malfunction, and the process terminates.

Since suction cleaning of the third type involves rapid suctioning of ink from nozzles, there exists the possibility that the ink interface forming in proximity to the nozzle opening (termed a meniscus) will not return to its preferred shape upon completing of cleaning. In this embodiment, suction cleaning of the third type is followed by suction cleaning of the first type in order to gently suction out ink. Thus, even if the meniscus should become disrupted, the meniscus is reformed so that nozzle misfire possibly resulting therefrom can be prevented. Where the intensity of ink suction in suction cleaning of the third type is not such that the meniscus becomes disrupted, suction cleaning of the first type following suction cleaning of the third type (Steps S505, S508) may be dispensed with.

In this embodiment, cleaning is performed selectively only on a misfiring nozzle plate, so that cleaning may be carried out without suctioning ink from normally functioning nozzle plates. It is therefore possible to reduce ink consumption needed for cleaning, and to avoid causing misfire in nozzle plates that are currently functioning normally.

Since suction cleaning of the third type and suction cleaning of the second type have substantially the same ability to resolve misfires, suction cleaning of the second type may be used in place of suction cleaning of the third type.

In this embodiment, ejection testing is performed using first testing section 10A and second testing section 10B, making misfiring nozzles readily detectable, and enabling cleaning to be carried out efficiently. Ejection testing using a test pattern could be performed instead. By so doing, accurate ejection testing can be carried out based on actual printed results.

B2. Cleaning Sequence Embodiment 2

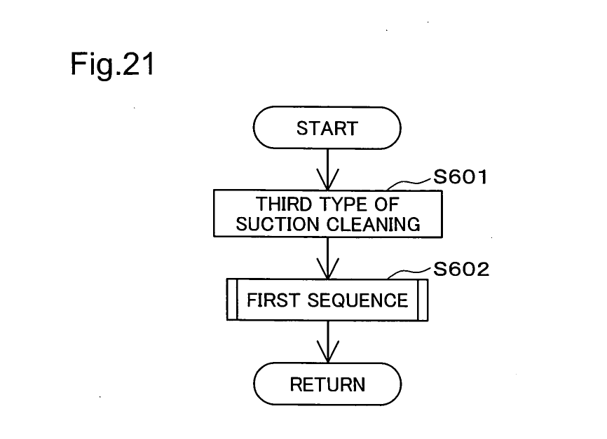

FIG. 21 is a flowchart showing a second sequence as an embodiment of a sequence for performing cleaning of a nozzle group. This sequence is implemented when refilling ink; when replacing ink tanks, namely sub-tanks 3a-3f (FIG. 2) or main tanks 9a-9f (FIG. 2); or when changing ink type.

First, in Step S601, suction cleaning of the third type (FIG. 13) described above is performed. In Step S601, cleaning is performed targeting all nozzle groups for cleaning. Once suction cleaning of the third type has been completed, the routine moves to Step S602.

In Step S602, the first sequence described above is performed. In the event that no misfire is found in Step S602, the sequence terminates.

When ink is refilled, when ink tanks, namely sub-tanks 3a-3f (FIG. 2) or main tanks 9a-9f (FIG. 2) are replaced, or when ink type is changed, there is a possibility of air bubbles or foreign matter becoming entrained in ink feed passages. Therefore, in this embodiment, misfires are prevented before they occur by performing suction cleaning of the third type on all nozzle groups. The second predetermined time interval in Step S601 is preferably longer than the second predetermined time interval for suction cleaning of the third type in the first sequence described previously. For example, it is preferably from 5 to 20 seconds, especially 8 to 15 seconds. By so doing, nozzles can be cleaned more forcefully even if foreign matter has become entrained.

When ink is refilled, when ink tanks are replaced, or when ink type is changed, control circuit 40 can detect the timing thereof in response to a user instruction entered through input/output section 240.

Alternatively, an arrangement may be possible wherein ink tanks are equipped with ink quantity sensors and control circuit 40 is provided with circuitry for reading out ink quantity sensor values, so that control circuit 40 can automatically detect ink refill timing, is also possible. Sensors of this kind may employ a Hall element and a magnetic body, for example. By so doing, optimal cleaning may be carried out automatically when ink is refilled.

In another possible arrangement, the section where an ink tank is installed may be equipped with a sensor for sensing the presence or absence of an ink tank, and control circuit 40 provided with circuitry for reading sensor output, so that control circuit 40 can automatically detect ink tank replacement timing (reinstallation timing). By so doing, optimal cleaning may be carried out automatically when an ink tank is replaced.

In yet another possible arrangement, means for storing information that identifies ink type is provided, and control circuit 40 provided with circuitry for reading out this identifying information, so that control circuit 40 can automatically detect ink type replacement timing. An arrangement wherein identifying information includes a predetermined threshold value Tcl (described later) decided depending on ink type, and the readout circuit reads out this value as well, is also possible. By so doing, optimal cleaning may be carried out automatically where the type of ink is changed.

B3. Cleaning Sequence Embodiment 3

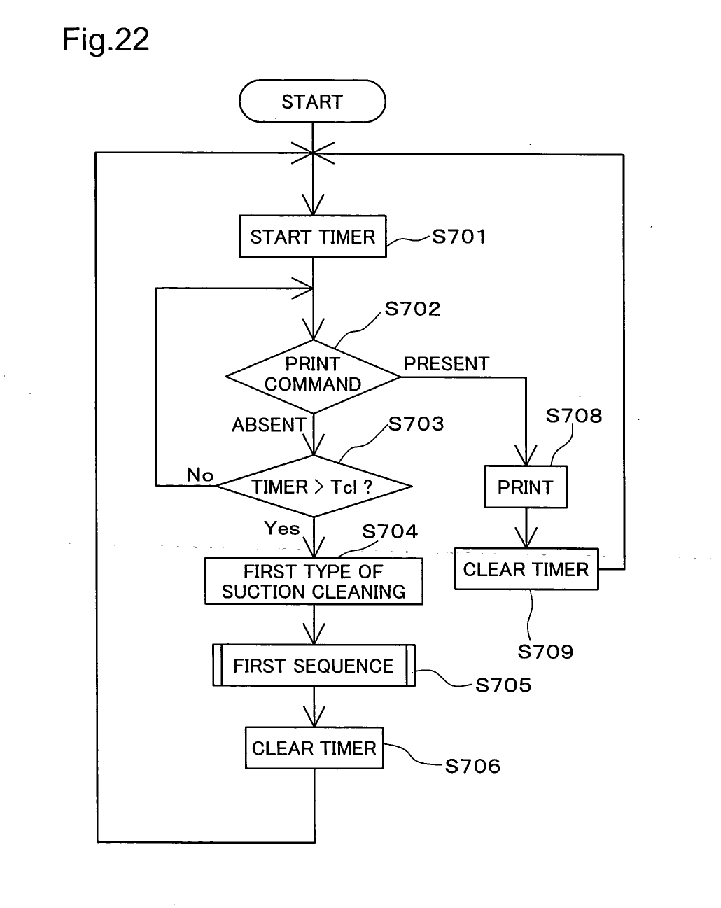

FIG. 22 is a flowchart showing a timer cleaning sequence carried out automatically as time passes. First, in Step S701, measurement of elapsed time by timer 68 commences. Next, in Step S702, it is determined whether there is a print command, and if there is no print command, the routine proceeds to Step S703. In Step S703, timer 68 compares elapsed time to the predetermined threshold value Tcl, and if elapsed time does not yet exceed predetermined threshold value Tcl, the routine returns to Step S702. Predetermined threshold value Tcl is a value preset depending on the type of ink. That is, when no job is currently printing, printer 200 awaits a print command according to the process flow between Step S702 and Step S703. In the event that there is a print command in Step S702, the routine proceeds to Step S708 in which printing is performed, then in Step S709 clears the elapsed time measured by timer 68, and then returns to Step S701 and resumes measurement of elapsed time by timer 68.

The timing at which the timer is restarted in Step S701 after elapsed time measured by timer 68 has been cleared in Step S709 may be timing selected such that after printer 200 has finished printing, cap set 21S hermetically seals nozzle plates 2 in order to prevent nozzles from drying out.

In the event that, as a result of awaiting a print command according to the process flow between Step S702 and Step S703, elapsed time measured by timer 68 is determined to exceed predetermined threshold value Tcl in Step S703, the routine proceeds to Step S704.

In Step S704, suction cleaning of the first type is performed, targeting all nozzle groups for cleaning. The routine then proceeds to Step S705 wherein the first sequence described above is executed. In the event that no misfire is detected in Step S705, elapsed time measured by timer 68 is cleared in Step S706, and the routine returns to Step S701 and restarts the timer.

In this embodiment, cleaning is performed at periodic time intervals (Tcl) even if printing has not been performed for an extended period, so that nozzle clogging due to dried ink can be prevented. This predetermined threshold value Tcl can be determined depending on ink type. For example, the threshold value Tcl for ink having a tendency to dry out will preferably be lower than the threshold value Tcl for ink that resists drying out. By so doing, cleaning can be carried out at optimal frequency for the type of ink being used. In preferred practice, threshold value Tcl will be set automatically with reference to ink type information input to input/output section 240. By so doing, cleaning can be carried out at optimal frequency for the type of ink being used. This threshold value Tcl may be stored in ink type identifier provided to the ink tank. By reading out this information, control circuit 40 can automatically set a threshold value Tcl, so that convenience for the user can be improved.

Cleaning sequence arrangements other than those described in the preceding embodiments are also possible; types of cleaning operations other than the first to third types of suction cleaning and wiping operations described hereinabove are also possible. Cleaning sequences may be set depending on various printing environment variables such as ink refill schedule, ink tank replacement schedule, elapsed time since last printing operation, ink type, temperature, humidity, or the like. Several different values for first predetermined time (FIG. 12), second predetermined time (FIG. 13), or predetermined threshold value Tcl (FIG. 22) may be used depending on the various printing environment variables mentioned above.

The invention is not limited to the embodiments described hereinabove, and may be reduced to practice in various ways without departing from the scope and spirit thereof. The following variants are possible, for example.

### C. Variant Examples

C1. Variant Example 1

The invention may also be implemented in a drum scan printer. The invention is not limited to implementation in a so-called ink jet printer, but is applicable generally to printing devices that print images by ejecting ink from a print head. Examples of such printing devices include facsimile machines and copy machines.

C2. Variant Example 2

In the embodiments described hereinabove, some of the arrangements realized through hardware could instead be replaced by software; or conversely, some of the arrangements realized through software could instead be replaced by hardware. For example, some of the functions of the control circuit 40 (FIG. 19) in printer 200 could instead by carried out by computer 90.

C3. Variant Example 3

In the embodiments described hereinabove, placement of testing units is such that a single testing unit 13 (FIG. 7) can test only a single print head 6; however, an arrangement of testing units 13 and print heads 6 whereby individual testing units 13 can test two or more print heads 6, but a single testing unit 13 cannot test all print heads 6, is also possible. However, where a number N (where N is an integer equal to 2 or greater) of print heads 6 are placed at mutually different locations in the sub-scanning direction SS, as in the example shown in FIG. 7, it is preferable for testing units 13 in a number equal to the number N of print heads 6 to be placed at mutually different location in the sub-scanning direction SS. In particular, testing units with an optical system that uses laser light or other type of light tend to have poorer sensor accuracy the greater the distance between the light emitter and light receiver. Accordingly, where N print heads 6 are arranged at different locations in a specific direction, it is preferable to provide a plurality of testing units and to make the distance between the light emitter and light receiver sufficiently short, from the standing point of sensor accuracy.

In the example in FIG. 2, a plurality of testing units are divided into two testing sections 13A, 13B situated to the outside of the two edges of the print medium; however, consolidated placement in either of these is possible. However, by dividing them among two testing sections 13A, 13B, it becomes possible for the two testing sections 13A, 13B to perform testing in alternating fashion as the carriage reciprocates in the main scanning direction, and as a result, testing time is shorter and testing efficiency is improved. Testing units are not limited to optical testing units that determine whether ink is ejected depending on whether testing light is blocked by ink dots, it being possible to use other types of testing units.

### INDUSTRIAL APPLICABILITY

The printer pertaining to this invention is applicable to printers, copiers, facsimile machines, and other devices that eject ink using piezo-elements, heaters, or various other kinds of actuators.

1. A printing device comprising a plurality of nozzle groups composed of nozzles supplied with ink from a common ink feed passage, for printing images by means of ejecting ink from the nozzles onto a print medium, the printing device further comprising:
a cleaning section for cleaning the nozzles of the nozzle groups; and
a controller for executing a predetermined operation to test for ink misfire by the nozzles, and for controlling operation of the cleaning section;
and wherein the controller selects a target nozzle group targeted for cleaning based on the ejection test result.

2. A printing device according to claim 1 wherein the controller determines a nozzle cleaning sequence with reference to at least one parameter selected from ink refill schedule, ink tank replacement schedule, time elapsed since last printing operation, and ink type.

3. A printing device according to claim 1 or 2 further comprising:
a testing unit having a light emitter for emitting light and a light receiver for receiving light, the testing unit being able to perform ink ejection testing of nozzles;
wherein the controller has a first ejection test mode wherein an ink droplet is ejected from a nozzle such that path of ink the droplet from the nozzle intersect the light, in order to detect misfire of the nozzle.

4. A printing device according to any of claims 1 to 3 wherein the controller comprises:
a test pattern printing section for printing a test pattern; and
an input section permitting a user to input a misfiring nozzle designation,
and wherein the controller has a second ejection test mode wherein ink misfire is detected in response to user input to the input section.

5. A printing device according to any of claims 1 to 4 wherein the cleaning section comprises:
a plurality of caps each hermetically covering at least one nozzle group; and
a suctioning section for suctioning out gas present within the hermetic space between each cap and nozzle group;
and wherein the controller has a cleaning mode wherein a nozzle group is provided hermetic closure using at least the cap facing the nozzle group targeted for the cleaning.

6. A printing device according to claim 5 wherein
the caps are connected to the suctioning section by means of suctioning passages each having first opening/closing means; and
the controller has a mode for performing a first type of suction cleaning wherein a target nozzle group is cleaned while closing the opening/closing means corresponding to caps other than the cap providing hermetic closure to the nozzle group targeted for the cleaning.

7. A printing device according to claim 5 or 6 wherein
the caps are connected to the suctioning section by means of suctioning passages each having first opening/closing means; and
the controller has a mode for performing a second type of suction cleaning wherein a target nozzle group targeted for the cleaning is cleaned by means of opening the first opening/closing means corresponding to the cap providing hermetic closure to the nozzle group after the opening/closing means has been closed for a first predetermined time interval, during operation of the suctioning section.

8. A printing device according to any of claims 5 to 7 wherein
the ink feed passages for the nozzle groups each have second opening/closing means; and
the controller has a mode for performing a third type of suction cleaning wherein a target nozzle group targeted for the cleaning is cleaned by means of opening the second opening/closing means of the nozzle group after it has been closed for a second predetermined time interval, during operation of the suctioning section.

9. A printing device according to any of claims 5 to 8 wherein
the suctioning section comprises suctioning means whose suction force is adjustable; and
the controller selects the suction force of the suctioning means depending on the type of cleaning.

10. A printing device according to any of claims 5 to 9 wherein
the suctioning section comprises a plurality of suctioning means having different levels of suction force; and
the controller selects the suctioning means depending on the type of cleaning.

11. A printing device according to any of claims 5 to 10 wherein
the cleaning section comprises a plurality of wiper blades composed of resilient elements, for wiping the openings of the nozzles; and
the controller has a cleaning mode wherein nozzle openings of a nozzle group are wiped using at least that the wiper blade which faces the nozzle group targeted for cleaning.

12. A printing device according to any of claims 5 to 11 wherein
a plurality of the wiper blades are disposed at the cap locations; and the cap and the wiper blade corresponding to a given nozzle group are replaceable as a single unit.

13. A printing device according to claim 11 or 12 wherein
the controller is capable of offsetting the wiper blade from the nozzle group in a sub-scanning direction while positioning the wiper blade away from a plane that includes the nozzle, by means of moving at least either of the nozzle group and the wiper blade; and
the controller is also capable of performing the wiping by means of a suitable combination of a first operation wherein the wiper blade is brought into proximity with the nozzle group while being kept offset therefrom, and a second operation wherein the wiper blade moves in the sub-scanning direction.

14. A nozzle cleaning method for use in a printing device comprising a plurality of nozzle groups that receive supply of ink from a plurality of common ink feed passages, and a cleaning section for performing cleaning of the nozzles, the method comprising the steps of:
executing a predetermined operation to test for misfire of the nozzles;
selecting a target nozzle group as a target for cleaning based on the ejection test result; and
performing cleaning on the nozzle group targeted for cleaning.

15. A method according to claim 14 further comprising the step of determining a nozzle cleaning sequence with reference to at least one parameter selected from ink refill schedule, ink tank replacement schedule, time elapsed since last printing operation, and ink type.

16. A method according to claim 14 or 15 further comprising the step of:
testing each nozzle for ink misfire;
wherein the testing step comprises the step of ejecting an ink droplet from the nozzle such that path of the ink droplet from the nozzle intersect the light, in order to detect misfire of the nozzle.

17. A method according to claim 14 or 15 wherein the testing step comprises the steps of:
ejecting ink from the nozzles to print a test pattern;
receiving a misfiring nozzle designation according to the printed result of the test pattern; and
identifying nozzle misfire in response to the misfiring nozzle designation.

18. A method according to any of claims 14 to 17 wherein
the cleaning step comprises the steps of:
providing a plurality of caps each hermetically covering at least one nozzle group, and a suctioning section for suctioning gas from hermetic spaces between caps and nozzle groups; and
using at least the cap facing the nozzle group targeted for cleaning to hermetically close the target nozzle group.

19. A method according to claim 18 wherein
each the cap is connected to the suctioning section by means of a suctioning passage equipped with first opening/closing means; and
the cleaning step comprises the step of:
performing a first type of suction cleaning wherein the target nozzle group is cleaned while closing the first opening/closing means corresponding to caps other than the cap hermetic closing the nozzle group targeted for the cleaning.

20. A method according to claim 18 wherein
each the cap is connected to the suctioning section by means of a suctioning passage equipped with first opening/closing means; and
the cleaning step comprises the step of:
performing a second type of suction cleaning wherein the target nozzle group is cleaned by means of opening the first opening/closing means corresponding to the cap providing hermetic closure to the nozzle group after the opening/closing means has been closed for a first predetermined time interval, during operation of the suctioning section.

21. A method according to claim 18 wherein
each the ink feed passage for the nozzle groups is equipped with second opening/closing means; and
the cleaning step comprises the step of:
performing a third type of suction cleaning wherein the target nozzle group is cleaned by means of opening the second opening/closing means of the nozzle group after the second opening/closing means has been closed for a second predetermined time interval, during operation of the suctioning section.

22. A method according to claim 18 wherein the cleaning step comprises the step of:
selecting a level of suction force for the cleaning with reference to a type of cleaning being performed.

23. A method according to claim 22 further comprising the step of:
providing a plurality of suctioning means with different levels of suction force;
wherein the cleaning step comprises the step of:
selecting a suctioning means with reference to the type of cleaning being performed.

24. A method according to any of claims 18 to 23 further comprising the step of:
providing a plurality of wiper blades composed of resilient elements, for wiping openings of the nozzles;
wherein the cleaning step comprises the step of:
wiping nozzle openings of a nozzle group using at least the wiper blade which faces the nozzle group targeted for cleaning.

25. A method according to claim 24 wherein
a plurality of the wiper blades are disposed at the cap locations; and the cap and the wiper blade corresponding to a given nozzle group are replaceable as a single unit.

26. A method according to claim 24 or 25 wherein the wiping step comprises the steps of:
moving at least either of the nozzle group and the wiper blade such that the wiper blade is offset in a sub-scanning direction from the nozzle group and positioned away from a plane that includes the nozzle; and
performing the wiping by means of a suitable combination of a first operation wherein the wiper blade is brought into proximity with the nozzle group while being kept offset therefrom, and a second operation wherein the wiper blade moves in the sub-scanning direction.

27. A computer program product for controlling a printing device comprising a plurality of nozzle groups that receive supply of ink from a plurality of common ink feed passages, and a cleaning section for performing cleaning of the nozzles, the computer program product comprising:
a computer-readable medium; and
a computer program stored on the computer-readable medium, the computer program comprising:
a first program for executing a predetermined operation to test the nozzles for ink misfire; and
a second program for selecting a target nozzle group targeted for cleaning, based on the ejection testing result.
